(19) United States
(12) Patent Application Publication
(10) Pub. No.: US 2026/0172928 A1
(43) Pub. Date: Jun. 18, 2026

(54) PROCEDURES FOR LAYER 1 / LAYER 2 MOBILITY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/126,005

(22) PCT Filed: Oct. 26, 2023
(86) PCT No.: PCT/CN2023/126669

§ 371 Date: Apr. 30, 2025

(30) Foreign Application Priority Data
Nov. 3, 2022 (WO) PCT/CN2022/129450
Nov. 3, 2022 (WO) PCT/CN2022/129467

(51) Int. Cl. H04W 36/08; H04W 36/00

(52) U.S. Cl. CPC H04W 36/08; H04W 36/0058

(57) ABSTRACT

Aspects relate to Layer 1 and/or Layer 2 mobility. In some examples, a user equipment (UE) may be handed over from a first cell (e.g., an SpCell) to a second cell (e.g., an SpCell). In some examples, Layer 1 signaling and/or Layer 2 signaling may be used for the handover of the UE. In some examples, a UE may be configured for measurements or sounding reference signal transmissions for such a handover. In some examples, a UE may generate a set of measurement results associated with one or more beams, where the one or more beams are associated with one or more candidate special cells (SpCells) for Layer 1 or Layer 2 mobility. The UE may transmit a beam report for the one or more beams, where the beam report is based on the set of measurement results.

### CROSS-REFERENCE TO RELATED APPLICATION(S)

This application claims priority to and the benefit of Patent Cooperation Treaty application number PCT/CN2022/129450, filed on Nov. 3, 2022, and Patent Cooperation Treaty application number PCT/CN2022/129467, filed on Nov. 3, 2022, the entire content of each of which is incorporated herein by reference.

### TECHNICAL FIELD

The technology discussed below relates generally to wireless communication and, more particularly but not exclusively, to mobility procedures.

### INTRODUCTION

Next-generation wireless communication systems (e.g., 5GS) may include a 5G core network and a 5G radio access network (RAN), such as a New Radio (NR)-RAN. The NR-RAN supports communication via one or more cells. For example, a wireless communication device such as a user equipment (UE) may access a first cell of a first base station (BS) such as a gNB and/or access a second cell of a second base station. A base station may schedule access to a cell to support access by multiple UEs. For example, a base station may allocate different resources (e.g., time domain and frequency domain resources) to be used by different UEs operating within the cell.

Different cells may serve a UE at different times. For example, a UE may initially be served by a first cell. Subsequently, an additional cell may be selected to serve the UE (e.g., to provide additional resources for serving the UE). Alternatively, or in addition, a cell that is serving the UE may be changed (switched out) whereby a different cell will serve the UE.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In some examples, a user equipment may include one or more memories storing processor-executable code, and one or more processors. The one or more processors may be configured to execute the processor-executable code and cause the user equipment to conduct a Layer 1 measurement based on a reference signal received from a first cell. The one or more processors also may be configured to execute the processor-executable code and cause the user equipment to generate a measurement report based on the Layer 1 measurement. The one or more processors may further be configured to execute the processor-executable code and cause the user equipment to transmit the measurement report to a second cell via a Layer 1 message.

In some examples, a method for wireless communication at a user equipment is disclosed. The method may include conducting a Layer 1 measurement based on a reference signal received from a first cell. The method may also include generating a measurement report based on the Layer 1 measurement. The method may further include transmitting the measurement report to a second cell via a Layer 1 message.

In some examples, a user equipment may include means for conducting a Layer 1 measurement based on a reference signal received from a first cell. The user equipment may also include means for generating a measurement report based on the Layer 1 measurement. The user equipment may further include means for transmitting the measurement report to a second cell via a Layer 1 message.

In some examples, a non-transitory computer-readable medium has stored therein instructions executable by one or more processors of a user equipment device to conduct a Layer 1 measurement based on a reference signal received from a first cell. The computer-readable medium may also have stored therein instructions executable by one or more processors of the user equipment to generate a measurement report based on the Layer 1 measurement. The computer-readable medium may further have stored therein instructions executable by one or more processors of the user equipment to transmit the measurement report to a second cell via a Layer 1 message.

In some examples, a first network entity may include one or more memories storing processor-executable code, and one or more processors. The one or more processors may be configured to execute the processor-executable code and cause the first network entity to generate a set of measurement results associated with one or more beams, where the one or more beams are associated with one or more candidate special cells (SpCells) for Layer 1 (L1) or Layer 2 (L2) mobility. The one or more processors also may be configured to execute the processor-executable code and cause the first network entity to transmit, to a second network entity, a beam report for the one or more beams, where the beam report is based on the set of measurement results.

In some examples, a method for wireless communication at a first network entity is disclosed. The method may include generating a set of measurement results associated with one or more beams, where the one or more beams are associated with one or more candidate special cells (SpCells) for Layer 1 (L1) or Layer 2 (L2) mobility. The method may also include transmitting, to a second network entity, a beam report for the one or more beams, where the beam report is based on the set of measurement results.

In some examples, a first network entity may include means for generating a set of measurement results associated with one or more beams, where the one or more beams are associated with one or more candidate special cells (SpCells) for Layer 1 (L1) or Layer 2 (L2) mobility. The first network entity may also include means for transmitting, to a second network entity, a beam report for the one or more beams, where the beam report is based on the set of measurement results.

In some examples, a non-transitory computer-readable medium has stored therein instructions executable by one or more processors of a first network entity device to generate a set of measurement results associated with one or more beams, where the one or more beams are associated with one or more candidate special cells (SpCells) for Layer 1 (L1) or Layer 2 (L2) mobility. The computer-readable medium may also have stored therein instructions executable by one or more processors of the first network entity to transmit, to a second network entity, a beam report for the one or more beams, where the beam report is based on the set of measurement results.

These and other aspects of the disclosure will become more fully understood upon a review of the detailed description which follows. Other aspects, features, and examples of the present disclosure will become apparent to those of ordinary skill in the art, upon reviewing the following description of specific, example aspects of the present disclosure in conjunction with the accompanying figures. While features of the present disclosure may be discussed relative to certain examples and figures below, all examples of the present disclosure can include one or more of the advantageous features discussed herein. In other words, while one or more examples may be discussed as having certain advantageous features, one or more of such features may also be used in accordance with the various examples of the disclosure discussed herein. In similar fashion, while example aspects may be discussed below as device, system, or method examples it should be understood that such example aspects can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a diagram providing a high-level illustration of one example of a configuration of a disaggregated base station according to some aspects.

FIG. 4 is a diagram illustrating an example of a base station and user equipment (UE) in an access network.

FIG. 5 is a schematic illustration of wireless resources in an air interface utilizing orthogonal frequency divisional multiplexing (OFDM) according to some aspects.

FIG. 6A is a diagram illustrating an example of a frame structure of synchronization signals for use in a wireless communication network according to some aspects.

FIG. 6B is a diagram illustrating an example of a portion of a frame or subframe structure with various channels and associated messages for use in a wireless communication network according to some aspects.

FIG. 7 is a signaling diagram of an example of random access channel (RACH) related signaling according to some aspects.

FIG. 8 is a conceptual illustration of an example of wireless communication via multiple cells according to some aspects.

FIG. 9 is a conceptual illustration of an example of uplink and downlink timing according to some aspects.

FIG. 10 is a signaling diagram of an example of RACH-based handover signaling according to some aspects.

FIG. 11 is a signaling diagram of an example of RACH-less handover signaling according to some aspects.

FIG. 12 is a conceptual illustration of an example of a handover according to some aspects.

FIG. 13 is a diagram illustrating an example of differences between L3 mobility and L1/L2 mobility according to some aspects.

FIG. 14 is a signaling diagram of an example of L1/L2 handover signaling according to some aspects.

FIG. 15 is a signaling diagram of an example of candidate cell measurement signaling according to some aspects.

FIG. 16 is a signaling diagram of an example of sounding reference signal (SRS) measurement signaling according to some aspects.

FIG. 17 is a conceptual illustration of an example of a guard band for an SRS according to some aspects.

FIG. 18 is a block diagram conceptually illustrating an example of a hardware implementation for a user equipment employing a processing system according to some aspects.

FIG. 19 is a flow chart illustrating an example wireless communication method involving a cell measurement according to some aspects.

FIG. 20 is a flow chart illustrating an example wireless communication method involving an SRS transmission according to some aspects.

FIG. 21 is a block diagram conceptually illustrating an example of a hardware implementation for a network entity employing a processing system according to some aspects.

FIG. 22 is a flow chart illustrating an example wireless communication method involving measurement reporting according to some aspects.

FIG. 23 is a flow chart illustrating an example wireless communication method involving SRS processing according to some aspects.

FIG. 24 is a diagram illustrating example communications between a network entity and a UE.

FIG. 25 is a flow chart illustrating an example wireless communication method involving transmitting a beam report according to some aspects.

FIG. 26 is a flow chart illustrating an example wireless communication method involving a prohibit timer according to some aspects.

FIG. 27 is a flow chart illustrating an example wireless communication method involving receiving a beam report according to some aspects.

FIG. 28 is a flow chart illustrating an example wireless communication method involving triggering a beam report according to some aspects.

FIG. 29 is a diagram illustrating an example of a hardware implementation for an example apparatus and/or network entity.

FIG. 30 is a diagram illustrating an example of a hardware implementation for an example network entity.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, artificial intelligence-enabled (AI-enabled) devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF) chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or UE), end-user devices, etc., of varying sizes, shapes, and constitution.

Various aspects of the disclosure relate to handover procedures. For example, a user equipment (UE) may be handed-over from a first cell (e.g., an SpCell) to a second cell (e.g., an SpCell). In some examples, Layer 1 (L1) signaling and/or Layer 2 (L2) signaling may be used to handover the UE from the first cell to the second cell. In some examples, the handover may omit a random access channel (RACH) procedure.

The disclosure relates in some aspects to measurements of candidate cells for L1/L2 handover. For example, a serving cell may configure a UE with information that the UE uses to measure a channel state information-reference signal (CSI-RS) or a synchronization signal block (SSB) transmitted by a candidate cell.

The disclosure relates in some aspects to sounding reference signal (SRS) measurements for L1/L2 handover. For example, a serving cell may configure a UE with information that the UE uses to transmit an SRS that can be measured by a candidate cell.

Various aspects of the disclosure relate to a first network entity generating a set of measurement results associated with one or more beams, where the one or more beams are associated with one or more candidate special cells (SpCells) for layer 1 (L1) or layer 2 (L2) mobility. The first network entity may also transmit, to a second network entity, a beam report for the one or more beams, where the beam report is based on the set of measurement results.

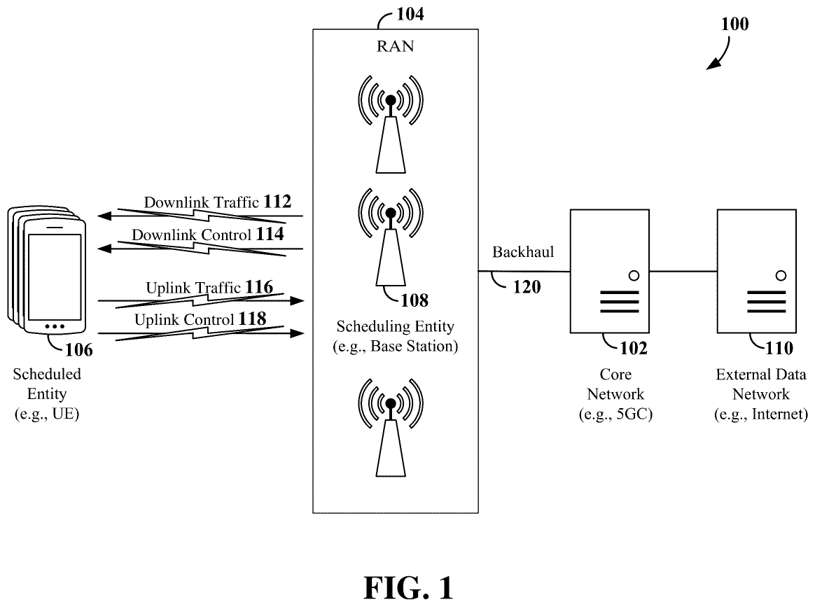

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long-Term Evolution (LTE). The 3GPP refers to this hybrid RAN as a next-generation RAN, or NG-RAN. In another example, the RAN 104 may operate according to both the LTE and 5G NR standards. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations 108 may be an LTE base station, while another base station may be a 5G NR base station.

The radio access network 104 is further illustrated supporting wireless communication for multiple mobile apparatuses. A mobile apparatus may be referred to as user equipment (UE) 106 in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE 106 may be an apparatus that provides a user with access to network services. In examples where the RAN 104 operates according to both the LTE and 5G NR standards, the UE 106 may be an Evolved-Universal Terrestrial Radio Access Network-New Radio dual connectivity (EN-DC) UE that is capable of simultaneously connecting to an LTE base station and an NR base station to receive data packets from both the LTE base station and the NR base station.

Within the present document, a mobile apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc., electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an Internet of Things (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide for connected medicine or telemedicine support, i.e., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In some examples, the term downlink may refer to a point-to-multipoint transmission originating at a base station (e.g., base station 108). Another way to describe this point-to-multipoint transmission scheme may be to use the term broadcast channel multiplexing. Transmissions from a UE (e.g., UE 106) to a base station (e.g., base station 108) may be referred to as uplink (UL) transmissions. In some examples, the term uplink may refer to a point-to-point transmission originating at a UE (e.g., UE 106).

In some examples, access to the air interface may be scheduled, wherein a scheduling entity (e.g., a base station 108) of some other type of network entity allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs). That is, for scheduled communication, a plurality of UEs 106, which may be scheduled entities, may utilize resources allocated by a scheduling entity (e.g., a base station 108).

Base stations 108 are not the only entities that may function as scheduling entities. That is, in some examples, a UE may function as a scheduling entity, scheduling resources for one or more scheduled entities (e.g., one or more other UEs). For example, UEs may communicate with other UEs in a peer-to-peer or device-to-device fashion and/or in a relay configuration.

As illustrated in FIG. 1, a scheduling entity (e.g., a base station 108) may broadcast downlink traffic 112 to one or more scheduled entities (e.g., a UE 106). Broadly, the scheduling entity is a node or device responsible for scheduling traffic in a wireless communication network, including the downlink traffic 112 and, in some examples, uplink traffic 116 and/or uplink control information 118 from one or more scheduled entities to the scheduling entity. On the other hand, the scheduled entity is a node or device that receives downlink control information 114, including but not limited to scheduling information (e.g., a grant), synchronization or timing information, or other control information from another entity in the wireless communication network such as the scheduling entity.

In addition, the uplink control information 118, downlink control information 114, downlink traffic 112, and/or uplink traffic 116 may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols in some examples. A subframe may refer to a duration of 1 millisecond (ms). Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

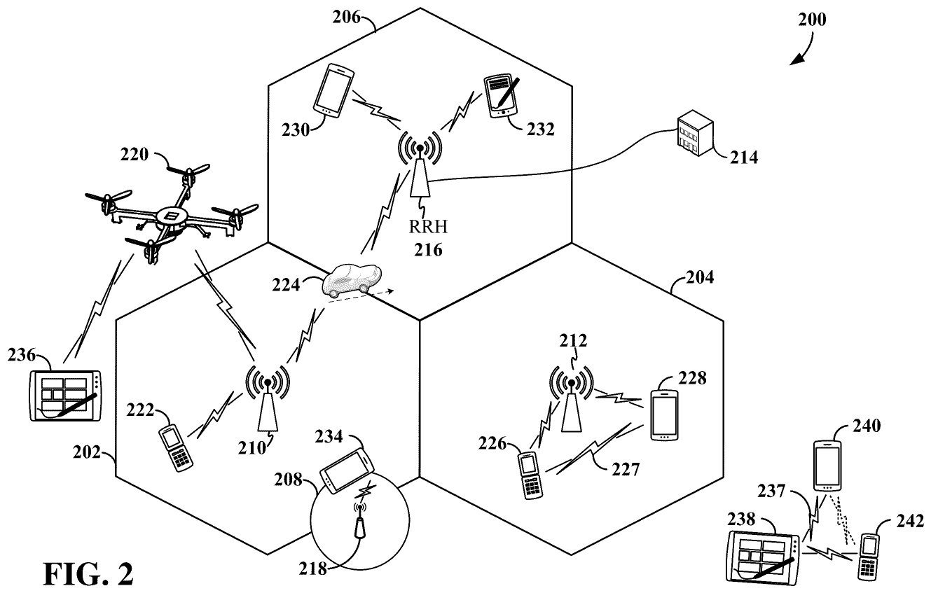

Referring now to FIG. 2, by way of example and without limitation, a schematic illustration of a radio access network (RAN) 200 is provided. In some examples, the RAN 200 may be the same as the RAN 104 described above and illustrated in FIG. 1.

The geographic area covered by the RAN 200 may be divided into cellular regions (cells) that can be uniquely identified by a user equipment (UE) based on an identification broadcasted from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, and 218 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; and UE 234 may be in communication with base station 218. In some examples, the UEs 222, 224, 226, 228, 230, 232, 234, 236, 238, 240, and/or 242 may be the same as the UE/scheduled entity described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In the RAN 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

A RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 (illustrated as a vehicle, although any suitable form of UE may be used) may move from the geographic area corresponding to its serving cell (e.g., the cell 202) to the geographic area corresponding to a neighbor cell (e.g., the cell 206). When the signal strength or quality from the neighbor cell exceeds that of the serving cell for a given amount of time, the UE 224 may transmit a reporting message to its serving base station (e.g., the base station 210) indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the network may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the RAN 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The air interface in the RAN 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the RAN 200 may further utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancelation technologies. Full-duplex emulation is frequently implemented for wireless links by utilizing frequency division duplex (FDD) or spatial division duplex (SDD). In FDD, transmissions in different directions operate at different carrier frequencies. In SDD, transmissions in different directions on a given channel are separate from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to as sub-band full-duplex (SBFD), cross-division duplex (xDD), or flexible duplex.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a centralized unit (CU) may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, the distributed unit (DU), and the radio unit (RU) can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

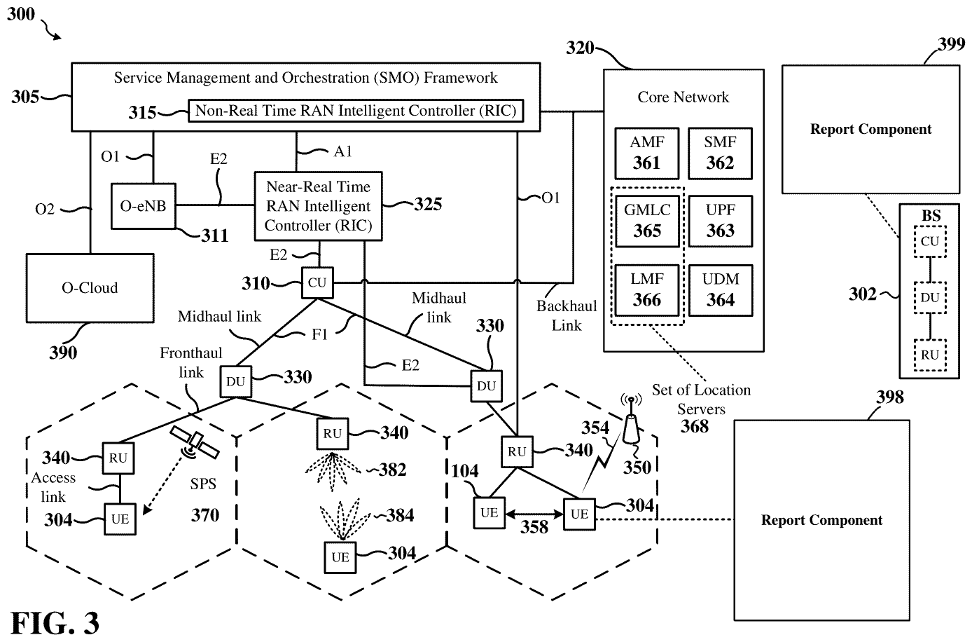

FIG. 3 is a diagram 300 illustrating an example of a wireless communications system and an access network. The illustrated wireless communications system includes a disaggregated base station architecture. The disaggregated base station architecture may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 304 via one or more radio frequency (RF) access links. In some implementations, the UE 304 may be simultaneously served by multiple RUs 340. In some examples, the UE 304 may correspond to any of the UEs or scheduled entities shown in any of FIGS. 1, 2, 4, 8-12, 14-16, 18, 24, 29, and 30.

Each of the units, i.e., the CUS 310, the DUs 330, the RUs 340, as well as the Near-RT RICs 325, the Non-RT RICs 315, and the SMO Framework 305, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as an E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 340 can be implemented to handle over the air (OTA) communication with one or more UEs 304. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements that may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUS 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

At least one of the CU 310, the DU 330, and the RU 340 may be referred to as a base station 302. Accordingly, the base station 302 may include one or more of the CU 310, the DU 330, and the RU 340 (each component indicated with dotted lines to signify that each component may or may not be included in the base station 302). In some examples, the base station 302 may correspond to any of the network entities, base stations, CUs, DUs, RUs, or scheduling entities shown in any of FIGS. 1, 2, 4, 8-12, 14-16, 21, 24, 29, and 30. The base station 302 provides an access point to the core network 320 for a UE 304. The base stations 302 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 340 and the UEs 304 may include uplink (UL) (also referred to as reverse link) transmissions from a UE 304 to an RU 340 and/or downlink (DL) (also referred to as forward link) transmissions from an RU 340 to a UE 304. The communication links may use multiple-input and multiple-output (MIMO) antenna technology, including spatial multiplexing, beamforming, and/or transmit diversity. The communication links may be through one or more carriers. The base stations 302/UEs 304 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 304 may communicate with each other using a device-to-device (D2D) communication link 358. The D2D communication link 358 may use the DL/UL wireless wide area network (WWAN) spectrum. The D2D communication link 358 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 350 in communication with UEs 304 (also referred to as Wi-Fi stations (STAs)) via communication link 354, e.g., in a 5 GHz unlicensed frequency spectrum or the like. When communicating in an unlicensed frequency spectrum, the UEs 304/AP 350 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz 7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 302 and the UE 304 may each include a plurality of antennas, such as antenna elements, antenna panels, and/or antenna arrays to facilitate beamforming. The base station 302 may transmit a beamformed signal 382 to the UE 304 in one or more transmit directions. The UE 304 may receive the beamformed signal from the base station 302 in one or more receive directions. The UE 304 may also transmit a beamformed signal 384 to the base station 302 in one or more transmit directions. The base station 302 may receive the beamformed signal from the UE 304 in one or more receive directions. The base station 302/UE 304 may perform beam training to determine the best receive and transmit directions for each of the base station 302/UE 304. The transmit and receive directions for the base station 302 may or may not be the same. The transmit and receive directions for the UE 304 may or may not be the same.

The base station 302 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 302 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 320 may include an Access and Mobility Management Function (AMF) 361, a Session Management Function (SMF) 362, a User Plane Function (UPF) 363, a Unified Data Management (UDM) 364, one or more location servers 368, and other functional entities. The AMF 361 is the control node that processes the signaling between the UEs 304 and the core network 320. The AMF 361 supports registration management, connection management, mobility management, and other functions. The SMF 362 supports session management and other functions. The UPF 363 supports packet routing, packet forwarding, and other functions. The UDM 364 supports the generation of authentication and key agreement (AKA) credentials, user identification handling, access authorization, and subscription management. The one or more location servers 368 are illustrated as including a Gateway Mobile Location Center (GMLC) 365 and a Location Management Function (LMF) 366. However, generally, the one or more location servers 368 may include one or more location/positioning servers, which may include one or more of the GMLC 365, the LMF 366, a position determination entity (PDE), a serving mobile location center (SMLC), a mobile positioning center (MPC), or the like. The GMLC 365 and the LMF 366 support UE location services. The GMLC 365 provides an interface for clients/applications (e.g., emergency services) for accessing UE positioning information. The LMF 366 receives measurements and assistance information from the NG-RAN and the UE 304 via the AMF 361 to compute the position of the UE 304. The NG-RAN may utilize one or more positioning methods in order to determine the position of the UE 304. Positioning the UE 304 may involve signal measurements, a position estimate, and an optional velocity computation based on the measurements. The signal measurements may be made by the UE 304 and/or the serving base station 302. The signals measured may be based on one or more of a satellite positioning system (SPS) 370 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 304 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 304 may be referred to as IoT devices (e.g., parking meter, gas pump, toaster, vehicles, heart monitor, etc.). The UE 304 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 3, in some aspects, the UE 304 may include a report component 398. In some aspects, the report component 398 may be configured to generate a set of measurement results associated with one or more beams, where the one or more beams are associated with one or more candidate SpCells for L1 or L2 mobility. In some aspects, the report component 398 may be further configured to transmit, to a second network entity, a beam report for the one or more beams, where the beam report is based on the set of measurement results. In some aspects, the report component 398 may be configured to generate a measurement report and transmit the measurement report to another node (e.g., the base station 302).

In certain aspects, the base station 302 may include a report component 399. In some aspects, the report component 399 may be configured to establish a connection with a second network entity. In some aspects, the report component 399 may be further configured to receive a beam report for one or more beams associated with a second network entity, where the one or more beams are associated with one or more candidate SpCells for L1 or L2 mobility, where the beam report is based on a set of measurement results, associated with the one or more beams, where the one or more beams are associated with one or more candidate SpCells for L1 or L2 mobility. In some aspects, the report component 399 may be configured to generate a measurement configuration and cause the measurement configuration to be transmitted to another node (e.g., the user equipment 304). In addition, the report component 399 may be configured to receive a measurement report from another node (e.g., the user equipment 304), generate a cell switch command based on the measurement report, and cause the cell switch command to be transmitted to another node (e.g., the user equipment 304).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

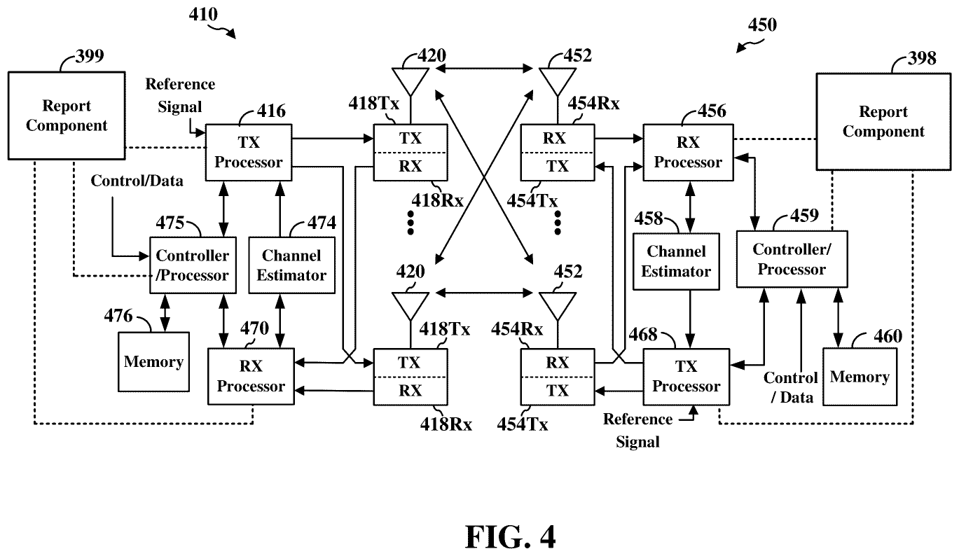

FIG. 4 is a block diagram of a base station 410 in communication with a UE 450 in an access network. In some examples, the base station 410 may correspond to any of the network entities, base stations, CUs, DUs, RUs, or scheduling entities shown in any of FIGS. 1-3, 8-12, 14-16, 21, 24, 29, and 30. In some examples, the UE 450 may correspond to any of the UEs or scheduled entities shown in any of FIGS. 1-3, 8-12, 14-16, 18, 24, 29, and 30.

In the DL, Internet protocol (IP) packets may be provided to one or more controllers/processors (referred to herein as the controller/processor 475, for convenience). The controller/processor 475 implements Layer 3 and Layer 2 functionality. Layer 3 includes a radio resource control (RRC) layer, and Layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

One or more transmit (TX) processors (represented generally by the TX processor 416) and one or more receive (RX) processors (represented generally by the RX processor 470) implement Layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna 420 via a separate transmitter 418Tx. Each transmitter 418Tx may modulate a radio frequency (RF) carrier with a respective spatial stream for transmission.

At the UE 450, each receiver 454Rx receives a signal through its respective antenna 452. Each receiver 454Rx recovers information modulated onto an RF carrier and provides the information to one or more receive (RX) processors (represented generally by the RX processor 456) implement Layer 1 functionality associated with various signal processing functions. One or more transmit (TX) processors (represented generally by the TX processor 468) and the RX processor 456 implement Layer 1 functionality associated with various signal processing functions. The RX processor 456 may perform spatial processing on the information to recover any spatial streams destined for the UE 450. If multiple spatial streams are destined for the UE 450, they may be combined by the RX processor 456 into a single OFDM symbol stream. The RX processor 456 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to one or more controllers/processors (referred to herein as the controller/processor 459, for convenience), which implements Layer 3 and Layer 2 functionality.

The controller/processor 459 can be associated with one or more memories (referred to herein as the memory 460, for convenience) that stores program codes and data. The memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using a positive acknowledgement (ACK) and/or a negative acknowledgement (NACK) protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna 452 via separate transmitters 454Tx. Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna 420. Each receiver 418Rx recovers information modulated onto an RF carrier and provides the information to the RX processor 470.

The controller/processor 475 can be associated with one or more memories (referred to herein as the memory 476, for convenience) that stores program codes and data. The memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with report component 398 of FIG. 3.

At least one of the TX processor 416, the RX processor 470, and the controller/processor 475 may be configured to perform aspects in connection with report component 399 of FIG. 3.

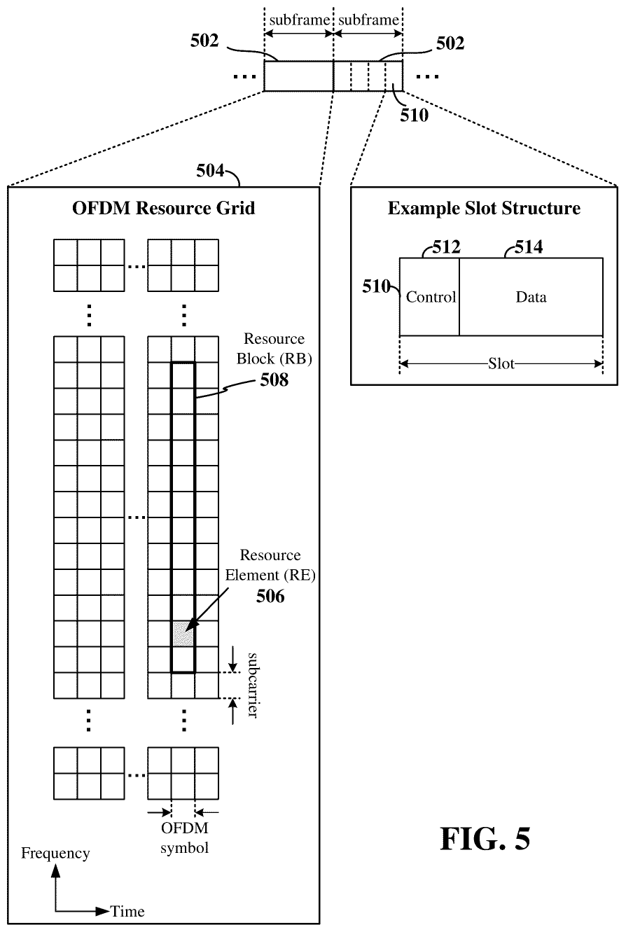

Various aspects of the present disclosure will be described with reference to an OFDM waveform, an example of which is schematically illustrated in FIG. 5. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 5, an expanded view of an example subframe 502 is illustrated, showing an OFDM resource grid. However, as those skilled in the art will readily appreciate, the physical (PHY) layer transmission structure for any particular application may vary from the example described here, depending on any number of factors. Here, time is in the horizontal direction with units of OFDM symbols; and frequency is in the vertical direction with units of subcarriers of the carrier.

The resource grid 504 may be used to schematically represent time-frequency resources for a given antenna port. In some examples, an antenna port is a logical entity used to map data streams to one or more antennas. Each antenna port may be associated with a reference signal (e.g., which may allow a receiver to distinguish data streams associated with the different antenna ports in a received transmission). An antenna port may be defined such that the channel over which a symbol on the antenna port is conveyed can be inferred from the channel over which another symbol on the same antenna port is conveyed. Thus, a given antenna port may represent a specific channel model associated with a particular reference signal. In some examples, a given antenna port and sub-carrier spacing (SCS) may be associated with a corresponding resource grid (including REs as discussed above). Here, modulated data symbols from multiple-input-multiple-output (MIMO) layers may be combined and re-distributed to each of the antenna ports, then precoding is applied, and the precoded data symbols are applied to corresponding REs for OFDM signal generation and transmission via one or more physical antenna elements. In some examples, the mapping of an antenna port to a physical antenna may be based on beamforming (e.g., a signal may be transmitted on certain antenna ports to form a desired beam). Thus, a given antenna port may correspond to a particular set of beamforming parameters (e.g., signal phases and/or amplitudes).

In a MIMO implementation with multiple antenna ports available, a corresponding multiple number of resource grids 504 may be available for communication. The resource grid 504 is divided into multiple resource elements (REs) 506. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 508, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 508 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 506 within one or more sub-bands or bandwidth parts (BWPs). Thus, a UE generally utilizes only a subset of the resource grid 504. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 508 is shown as occupying less than the entire bandwidth of the subframe 502, with some subcarriers illustrated above and below the RB 508. In a given implementation, the subframe 502 may have a bandwidth corresponding to any number of one or more RBs 508. Further, in this illustration, the RB 508 is shown as occupying less than the entire duration of the subframe 502, although this is merely one possible example.

Each 1 ms subframe 502 may consist of one or multiple adjacent slots. In the example shown in FIG. 5, one subframe 502 includes four slots 510, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 510 illustrates the slot 510 including a control region 512 and a data region 514. In general, the control region 512 may carry control channels, and the data region 514 may carry data channels. Of course, a slot may contain all DL, all UL, or at least one DL portion and at least one UL portion. The structure illustrated in FIG. 5 is merely an example, and different slot structures may be utilized, and may include one or more of each of the control region(s) and data region(s).

Although not illustrated in FIG. 5, the various REs 506 within an RB 508 may be scheduled to carry one or more physical channels, including control channels, shared channels, data channels, etc. Other REs 506 within the RB 508 may also carry pilots or reference signals. These pilots or reference signals may provide for a receiving device to perform channel estimation of the corresponding channel, which may enable coherent demodulation/detection of the control and/or data channels within the RB 508.

In some examples, the slot 510 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 506 (e.g., within the control region 512) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 506 (e.g., in the control region 512 or the data region 514) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional (remaining) system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the UE may utilize one or more REs 506 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 506 (e.g., within the data region 514) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 506 within the data region 514 may be configured to carry other signals, such as one or more SIBs and DMRSs.

In an example of sidelink communication over a sidelink carrier via a proximity service (ProSe) PC5 interface, the control region 512 of the slot 510 may include a physical sidelink control channel (PSCCH) including sidelink control information (SCI) transmitted by an initiating (transmitting) sidelink device (e.g., a transmitting (Tx) V2X device or other Tx UE) towards a set of one or more other receiving sidelink devices (e.g., a receiving (Rx) V2X device or some other Rx UE). The data region 514 of the slot 510 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 506 within slot 510. For example, HARQ feedback information may be transmitted in a physical sidelink feedback channel (PSFCH) within the slot 510 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 510.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers described above with reference to FIGS. 1-5 are not necessarily all of the channels or carriers that may be utilized between a scheduling entity and scheduled entities, and those of ordinary skill in the art will recognize that other channels or carriers may be utilized in addition to those illustrated, such as other traffic, control, and feedback channels.

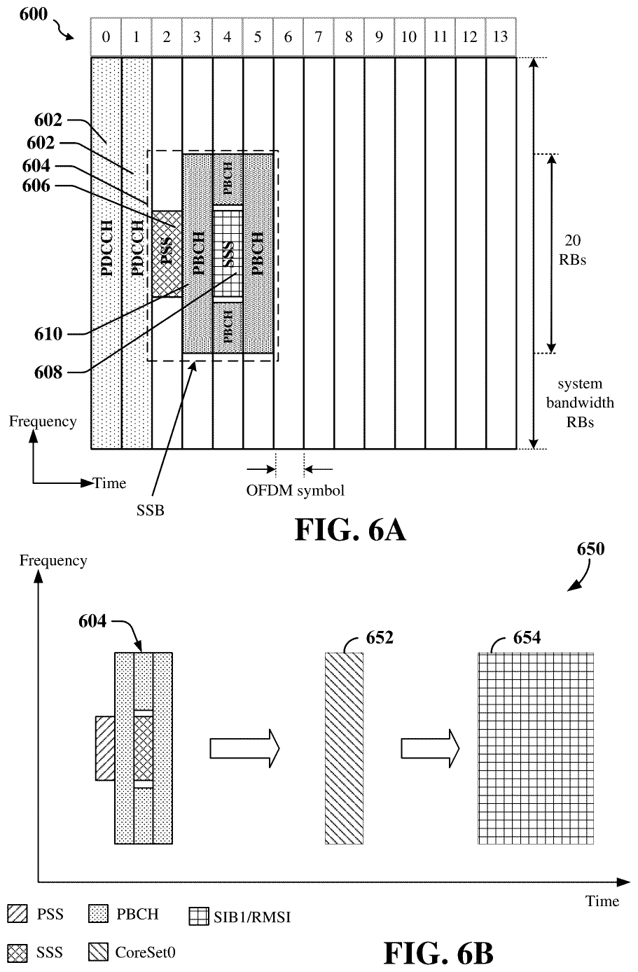

FIG. 6A illustrates an example 600 of various downlink channels within a subframe of a frame including channels used for initial access and synchronization. As shown in FIG. 6A, a physical downlink control channel (PDCCH) 602 is transmitted in at least two symbols (e.g., symbol 0 and symbol 1) and may carry DCI within at least one control channel element (CCE), with each CCE including nine RE groups (REGs), and each RE group (REG) including four consecutive REs in an OFDM symbol. Additionally, FIG. 6A illustrates an exemplary synchronization signal block (SSB) 604 that may be periodically transmitted by a base station or gNB. The SSB 604 carries synchronization signals PSS 606 and SSS 608 and broadcast channels (PBCH) 610. In this example, the SSB 604 contains one PSS symbol (shown in symbol 2), one SSS symbol (shown in symbol 4) and two PBCH symbols (shown in symbols 3 and 5). The PSS and SSS combination may be used to identify physical cell identities. A UE uses the PSS to determine subframe/symbol timing and a physical layer identity. The SSS is used by a UE to determine a physical layer cell identity group number and radio frame timing. Based on the physical layer identity and the physical layer cell identity group number, the UE can determine a physical cell identifier (PCI). Also, based on the PCI, the UE can determine the locations of the aforementioned DMRS. The physical broadcast channel (PBCH), which carries a master information block (MIB), is logically grouped with the PSS and SSS to form the synchronization signal, i.e., the SSB 604. The MIB provides a number of RBs in the system bandwidth and a system frame number (SFN).

FIG. 6B is a diagram illustrating various broadcast information 650 related to initial cell access according to some examples. The broadcast information 650 may be transmitted by a RAN node (e.g., a base station, such as an eNB or gNB) on resources (e.g., time-frequency resources) allocated for the transmission of the broadcast information 650 in a cell. The broadcast information 650 includes the SSB 604 illustrated in FIG. 6A. It is noted that the PBCH in the SSB 604 includes the MIB carrying various system information (SI) including, for example, a cell barred indication, the subcarrier spacing, the system frame number, and scheduling information for a CORESET0 652. For example, the PBCH in the SSB 604 may include scheduling information indicating time-frequency resources allocated for the CORESET0 652. In some examples, the CORESET0 652 may be transmitted within the first four symbols (e.g., within a control region) of a slot. In addition, the CORESET0 652 carries a PDCCH with DCI that contains scheduling information for scheduling the SIB1 654. The SIB1 654 is carried within a physical downlink shared channel (PDSCH) within a data region of a slot. In addition, the SIB1 654 may be referred to as RMSI and includes, for example, a set of radio resource parameters providing network identification and configuration. For example, the set of radio resource parameters may include a bandwidth (e.g., number of BWPs) on which a UE may communicate with a base station.

The MIB in the PBCH may include system information (SI), along with parameters for decoding a SIB (e.g., SIB1). Examples of SI transmitted in the MIB may include, but are not limited to, a subcarrier spacing, a system frame number, a configuration of a PDCCH control resource set (CORESET) (e.g., PDCCH CORESET0), and a search space for SIB1. Examples of SI transmitted in the SIB1 may include, but are not limited to, a random access search space, downlink configuration information, and uplink configuration information. The MIB and SIB1 together provide the minimum SI for initial access.

A brief discussion of an initial access procedure for a UE using the above information follows. As discussed above, a base station (BS) may transmit synchronization signals (e.g., including PSS and SSS) in the network to enable UEs to synchronize with the BS, as well as SI (e.g., including a MIB, RMSI, and OSI) to facilitate initial network access. The BS may transmit the PSS, the SSS, and/or the MIB via SSBs over the PBCH and may broadcast the RMSI and/or the OSI over the PDSCH.

A UE attempting to access a RAN (e.g., the RAN 200 of FIG. 2) may perform an initial cell search by detecting a PSS from a BS (e.g., the PSS of a cell of the BS) of the RAN. The PSS may enable the UE to synchronize to period timing of the BS and may indicate a physical layer identity value assigned to the cell. The UE may also receive an SSS from the BS that enables the UE to synchronize on the radio frame level with the cell. The SSS may also provide a cell identity value, which the UE may combine with the physical layer identity value to identify the cell.

After receiving the PSS and SSS, the UE may receive the SI from the BS. The system information may take the form of the MIB and SIBs discussed above. The system information may include information that a UE can use to access the network such as downlink (DL) channel configuration information, uplink (UL) channel configuration information, access class information, and cell barring information, as well as other information. The MIB may include SI for initial network access and scheduling information for RMSI and/or OSI. After decoding the MIB, the UE may receive the RMSI and/or the OSI.

The SI includes information that enables a UE to determine how to conduct an initial access to a RAN. In some examples, the SIB2 includes random access configuration information (e.g., a random access channel (RACH) configuration) that indicates the resources that the UE is to use to communicate with the RAN during initial access. The random access configuration information may indicate, for example, the resources allocated by the RAN for a RACH procedure. For example, the RACH configuration may indicate the resources allocated by the network for the UE to transmit a physical random access channel (PRACH) preamble and to receive a random access response. In some examples, the RACH configuration identifies monitoring occasions (MOs) that specify a set of symbols (e.g., in a PRACH slot) that are scheduled by a base station for the PRACH procedure. The RACH configuration may also indicate the size of a random access response window during which the UE is to monitor for a response to a PRACH preamble. The RACH configuration may further specify that the random access response window starts a certain number of sub-frames after the end of the PRACH preamble in some examples. After obtaining the MIB, the RMSI and/or the OSI, the UE may thus perform a random access procedure for initial access to the RAN.

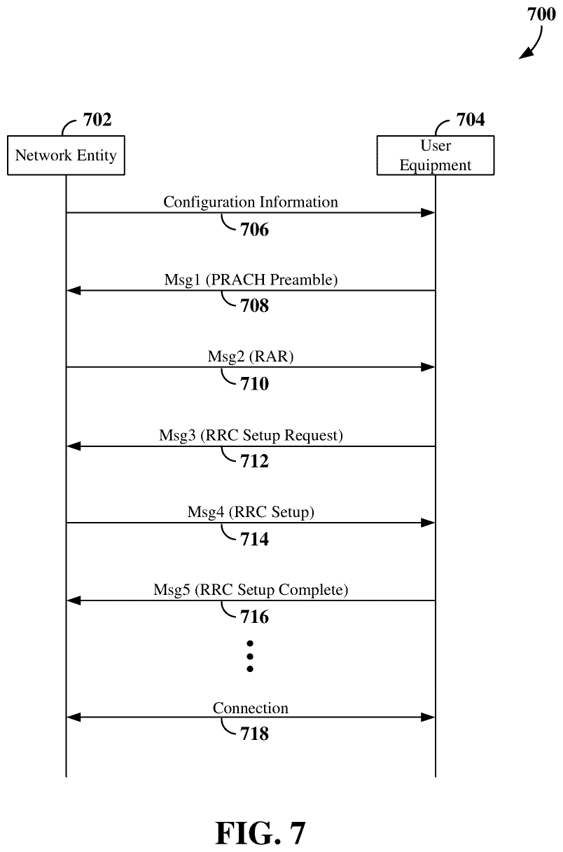

FIG. 7 is a signaling diagram 700 illustrating an example of signaling associated with a contention-based RACH procedure in a wireless communication system including a network entity (e.g., a base station) 702 and a user equipment 704. In some examples, the network entity 702 may correspond to any of the network entities, base stations, CUs, DUs, RUs, or scheduling entities shown in any of FIGS. 1-4, 8-12, 14-16, 21, 24, 29, and 30. In some examples, the user equipment 704 may correspond to any of the UEs or scheduled entities shown in any of FIGS. 1-4, 8-12, 14-16, 18, 24, 29, and 30.

At #706 of FIG. 7, the network entity 702 broadcasts configuration information that nearby devices (e.g., the user equipment 704) may use for a RACH procedure directed to the network entity 702. For example, the network entity 702 may broadcast the random access-related SI discussed above.

At #708 of FIG. 7, the user equipment 704 transmits a message 1 (which may be referred to as Msg1) of the RACH procedure to the network entity 702. In some examples, the Msg1 is a PRACH preamble. RACH Msg1 may be referred to as PRACH. As mentioned above, the user equipment 704 may transmit the PRACH preamble on resources specified by a RACH configuration included in SIB2.

At #710, the network entity 702 responds to the PRACH preamble with a message 2 (which may be referred to as Msg2) of the RACH procedure. The Msg2 may be referred to informally as a random access response (RAR). In some examples of 710, the network entity 702 transmits a DCI on a PDCCH, where the DCI schedules a PDSCH (e.g., the DCI specifies the resources for the PDSCH transmission). The network entity 702 then transmits the PDSCH which includes the RAR data such as, for example, an UL grant for the user equipment to transmit a message 3 (which may be referred to as Msg3) of the RACH procedure.

In some examples, the user equipment monitors for the RACH Msg2 on resources specified by the RACH configuration during the RAR window specified by the RACH configuration. For example, the user equipment may decode the DCI carried on the PDCCH and then decode the RAR carried on the PDSCH.

At #712, upon receiving all of the RAR information, the user equipment 704 transmits the Msg3 of the RACH procedure. In some examples, the RACH Msg3 is a radio resource control (RRC) Setup Request message.

At #714, the network entity 702 responds with a message 4 (which may be referred to as Msg4) of the RACH procedure. In some examples, the RACH Msg4 is an RRC Setup message (e.g., a contention resolution message).

At #716, the user equipment 704 responds with a message 5 (which may be referred to as Msg5) of the RACH procedure. In some examples, the RACH Msg5 is an RRC Setup Complete message. In some examples, if the user equipment 704 successfully decodes the RACH Msg 4, the transmission of RACH Msg5 may involve transmitting a PUCCH including a HARQ-ACK for the PDSCH data of RACH Msg4. In some examples, PUCCH frequency hopping may be used for this transmission of the RACH Msg5.

As indicated by 718, the network entity 702 and the user equipment 704 ultimately establish a connection and enter an active operational phase where data may be exchanged. For example, the network entity 702 may schedule the user equipment 704 for UL communication and/or DL communication.

5G-NR networks may further support carrier aggregation (CA) of component carriers transmitted from different cells and/or different transmission and reception points (TRPs) in a multi-cell transmission environment. The different TRPs may be associated with a single serving cell or multiple serving cells. In some aspects, the term component carrier may refer to a carrier frequency (or band) utilized for communication within a cell.

In some aspects, a TRP may refer to a physical entity that incorporates RU functionality for a particular physical cell. This functionality may be similar in one or more aspects to (or incorporated into) the RU functionality of a NodeB, an eNodeB, a gNodeB, a radio network controller (RNC), a base station (BS), a radio base station (RBS), a base station controller (BSC), a base transceiver station (BTS), a transceiver function (TF), a radio transceiver, a radio router, a basic service set (BSS), an extended service set (ESS), a macro cell, a macro node, a Home eNB (HeNB), or some other similar entity.

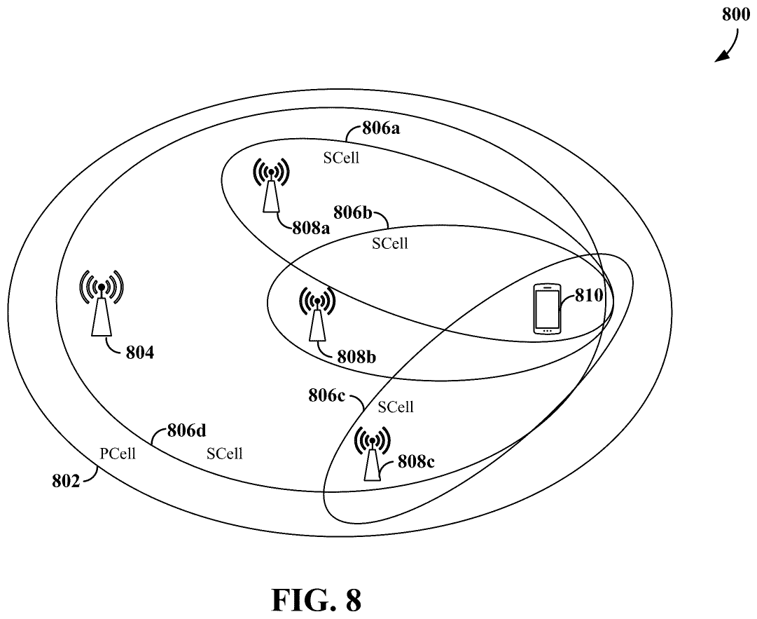

FIG. 8 is a conceptual illustration of a wireless communication system that shows a base station (BS) and a user equipment (UE) communicating via multiple carriers according to some aspects of the disclosure. In particular, FIG. 8 shows an example of a wireless communication system 800 that includes a primary serving cell (PCell) 802 and one or more secondary serving cells (SCells) 806a, 806b, 806c, and 806d. The PCell 802 may be referred to as the anchor cell that provides a radio resource control (RRC) connection to the UE 810. In some examples, the PCell and the SCell may be co-located (e.g., different TRPs at the same location). The UE 810 may correspond to any of the UEs or scheduled entities shown in any of FIGS. 1-4, 9-12, 14-16, 18, 24, 29, and 30.

One or more of the SCells 806a-806d may be activated or added to the PCell 802 to form the serving cells serving the UE 810. Each serving cell corresponds to a component carrier (CC). The CC of the PCell 802 may be referred to as a primary CC, and the CC of a SCell 806a-806d may be referred to as a secondary CC. The PCell 802 and one or more of the SCells 806 may be served by a respective base station 804 and 808a-808c or scheduling entity similar to those illustrated in any of FIGS. 1-4, 9-12, 14-16, 21, 24, 29, and 30. In the example shown in FIG. 8, SCells 806a-806c are each served by a respective base station 808a-808c. SCell 806d is co-located with the PCell 802. For example, the base station 804 may include multiple TRPs, each supporting a different carrier. The coverages of the PCell 802 and SCell 806d may differ since component carriers in different frequency bands may experience different path loss.

In some examples, the PCell 802 may add or remove one or more of the SCells 806a-806d to improve reliability of the connection to the UE 810 and/or increase the data rate. The PCell 802 may be changed upon a handover to another PCell.

In some examples, the PCell 802 may utilize a first radio access technology (RAT), such as LTE, while one or more of the SCells 806 may utilize a second RAT, such as 5G-NR. In this example, the multi-cell transmission environment may be referred to as a multi-RAT-dual connectivity (MR-DC) environment. One example of MR-DC is Evolved-Universal Terrestrial Radio Access Network (E-UTRAN)-New Radio (NR) dual connectivity (EN-DC) mode that enables a UE to simultaneously connect to an LTE base station and a NR base station to receive data packets from and send data packets to both the LTE base station and the NR base station.

In some examples, the PCell 802 may be a low band cell, and the SCells 806 may be high band cells. A low band (LB) cell uses a CC in a frequency band lower than that of the high band cells. For example, the high band cells may use millimeter wave (mmW) CC, and the low band cell may use a CC in a band (e.g., sub-6 GHz band) lower than mmW. In general, a cell using a mmW CC can provide greater bandwidth than a cell using a low band CC. In addition, when using a frequency carrier that is above 6 GHz (e.g., mmW), beamforming may be used to transmit and receive signals in some examples.

Various types of cells may be deployed in a wireless communication system in different examples. In some examples, a cell may be a special cell (SpCell) such as a primary cell (PCell), a primary secondary cell (PSCell), or a PUCCH secondary cell (PUCCH SCell). In some examples, an SpCell may be a PCell for a master cell group (MCG) or a PSCell for a secondary cell group (SCG).

For uplink transmissions, a 5G NR uplink allows for uplink intracell orthogonality so that the uplink transmissions received from different devices within a cell do not interfere with each other. To enable such uplink orthogonality, the uplink slot boundaries for a given numerology are (approximately) time aligned at the network entity. To ensure such receiver-side time alignment, a network entity may transmit a timing advance (TA) signal or indication to a UE so that the UE may adjust its uplink timing accordingly.

Generally, timing advance is a negative offset applied at a wireless device (e.g., a UE) between the start of a downlink (DL) symbol (or subframe) as observed by the device and the start of a symbol in the uplink (UL). By controlling the offset appropriately for each device, the network (e.g., a network entity such as a gNB) may control the timing of the signals received at the network entity from the various devices (UEs) in a cell being served. Devices located far from the network entity encounter a longer propagation delay, and, therefore, should start their uplink transmissions somewhat in advance, compared to devices located closer to the network entity that encounter a shorter propagation delay.

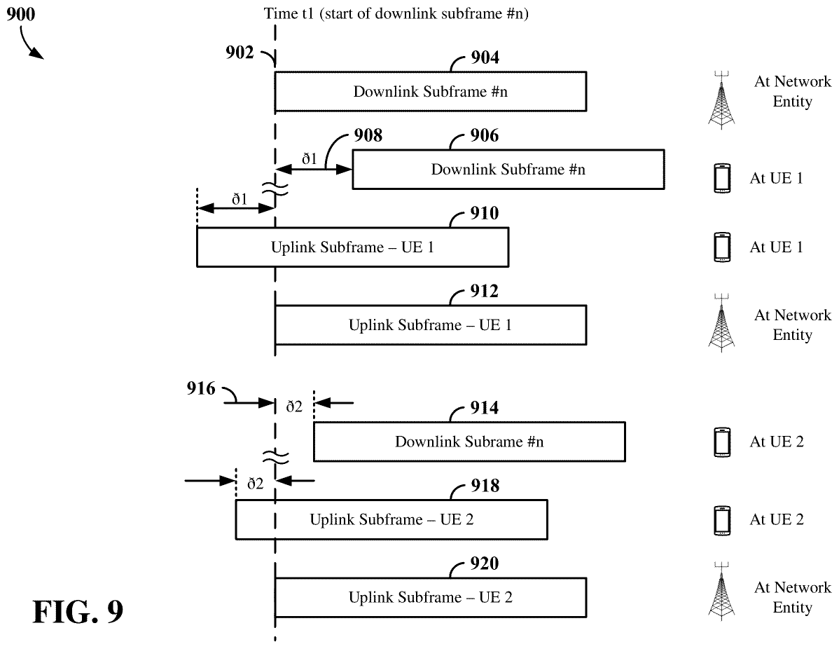

FIG. 9 illustrates an example 900 of downlink and uplink timing. In this example, a first UE (UE 1) is located further from a network entity (e.g., a gNB) than a second UE (UE 2). Time-aligned downlink transmissions and uplink transmissions are illustrated relative to a time t1 902 that represents a subframe boundary at the network entity. In some examples, the UEs of FIG. 9 may correspond to any of the UEs or scheduled entities shown in any of FIGS. 1-4, 8, 10-12, 14-16, 18, 24, 29, and 30. In some examples, the network entity of FIG. 9 may correspond to any of the network entities, base stations, CUs, DUs, RUs, or scheduling entities shown in any of FIGS. 1-4, 8, 10-12, 14-16, 21, 24, 29, and 30.

As represented by a downlink subframe 904 (designated as downlink subframe #n in this example), transmission of a downlink subframe at the network entity starts at the time t1 902. A downlink subframe 906 represents the delayed reception of the downlink subframe 904 at the first UE (UE 1). As indicated, the subframe 906 is received at the first UE (UE 1) after a propagation delay 81 908.

In some aspects, it may be desired that uplink transmissions be received at the network entity time aligned with the network entity's subframe boundary. To this end, based on a timing advance command received from the network entity, the first UE (UE 1) may transmit an uplink subframe 910 at a time that precedes the network entity's subframe boundary by the propagation delay 81. An uplink subframe 912 represents the delayed reception of the uplink subframe 910 at the network entity. As indicated, this uplink subframe is received time aligned with the network entity's subframe boundary. For convenience, the transmission of the uplink subframe is depicted relative to the time t1 902. It should be appreciated, however, that in a half-duplex system the relative subframe boundary for the uplink transmission would be later in time than the time t1 902.

FIG. 9 further illustrates that the propagation delay 82 from the network entity to the second UE (UE 2) is shorter than the propagation delay 81 due to the second UE (UE 2) being closer to the network entity than the first UE (UE 1). A downlink subframe 914 represents the delayed reception of the downlink subframe 904 at the second UE (UE 2). As indicated, the subframe 914 is received at the second UE (UE 2) after a propagation delay δ2 916.

Based on a timing advance command received from the network entity, the second UE (UE 2) may transmit an uplink subframe 918 at a time that precedes the network entity's subframe boundary by the propagation delay 82. An uplink subframe 920 represents the delayed reception of the uplink subframe 918 at the network entity. As indicated, this uplink subframe is received time aligned with the network entity's subframe boundary. For convenience, the transmission of the uplink subframe is again depicted relative to the time t1 902. It should be appreciated, however, that in a half-duplex system the relative subframe boundary for the uplink transmission would be later in time than the time t1 902.

Some wireless communication systems (e.g., 3GPP LTE and NR) use upper layer mobility (e.g., based on Layer 3, RRC signaling) to enable a UE to move from one cell to another. Here, the UE connects to a single cell at a time. For example, a UE may initially be connected to a serving cell. Subsequently, upon receiving a cell switch command, the UE may connect to a new cell.

As discussed above, a handover operation in such a system (e.g., based on Layer 3, RRC signaling) may involve a RACH procedure.

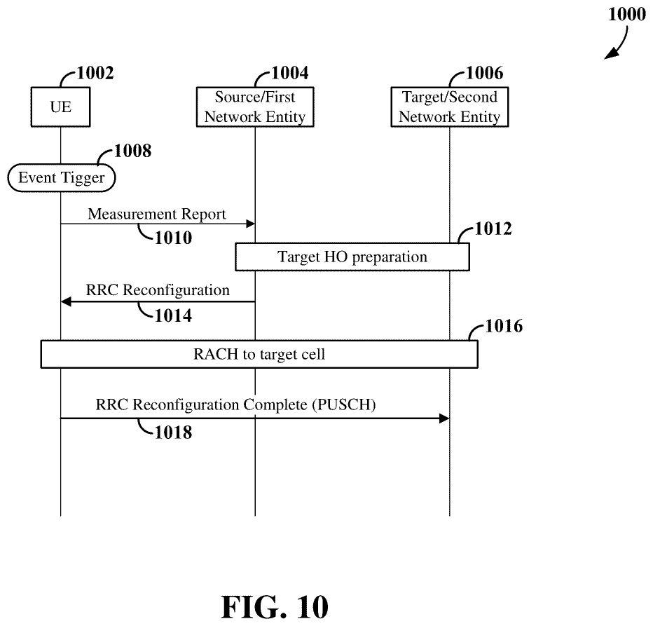

FIG. 10 is a signaling diagram 1000 illustrating an example of signaling associated with a RACH-based handover in a wireless communication system including a user equipment 1002, a first network entity 1004 (e.g., a source gNB), and a second network entity 1006 (e.g., a target gNB). In some examples, the user equipment 1002 may correspond to any of the UEs or scheduled entities shown in any of FIGS. 1-4, 7-9, 11-12, 14-16, 18, 24, 29, and 30. In some examples, the first network entity 1004 and the second network entity 1006 may correspond to any of the network entities, base stations, CUs, DUs, RUs, or scheduling entities shown in any of FIGS. 1-4, 7-9, 11-12, 14-16, 21, 24, 29, and 30.

At #1008 of FIG. 10, an event trigger may cause the user equipment 1002 to generate a measurement report (e.g., a measurement report message) and transmit the measurement report at #1010. For example, based on measurements of signals from the first network entity 1004 and one or more other network entities, the user equipment 1002 may determine that a measured signal falls below or above a particular threshold. Examples of event triggers used in 3GPP-based systems include Event A1 (serving cell>threshold), Event A2 (serving cell<threshold), Event A3 (neighbor cell>threshold+offset), Event A4 (neighbor cell>threshold), Event A5 (SpCell<threshold1 and neighbor cell>threshold2), and Event A6 (neighbor cell>SpCell+offset). Other event triggers may be used in other examples.

At #1012, based on the measurement report, the first network entity 1004 may elect to handover the user equipment to the second network entity 1006. Thus, the first network entity 1004 and the second network entity 1006 may cooperate to prepare the second network entity 1006 as the target for handover of the user equipment 1002.

At #1014, the first network entity 1004 sends an RRC reconfiguration message to the user equipment 1002 to inform the user equipment 1002 that it is being handed-over to the second network entity 1006. In some aspects, this RRC reconfiguration message may be referred to as (or referred to as including) a cell switch command.

At #1016, upon receiving the RRC configuration message, the user equipment 1002 conducts a RACH procedure (e.g., as discussed above in conjunction with FIG. 7) with the second network entity 1006. Here, upon receiving a PRACH from the user equipment 1002, the second network entity 1006 may determine a timing advance value, a power control value, and beam information that can be used (e.g., by the user equipment) to establish communication between the user equipment 1002 and the second network entity 1006.

At #1018, in conjunction with completing the RACH procedure, the user equipment 1002 sends an RRC reconfiguration complete message to the second network entity 1006. The user equipment 1002 may thereby be served by the second network entity 1006 instead of the first network entity 1004.

Some wireless communication systems (e.g., 3GPP LTE and NR) may support a RACH-less handover. For example, in certain defined scenarios (e.g., handover to or from a small cell), when initiating communication with a target cell a UE may use the same TA value that it used for communicating with the source cell.

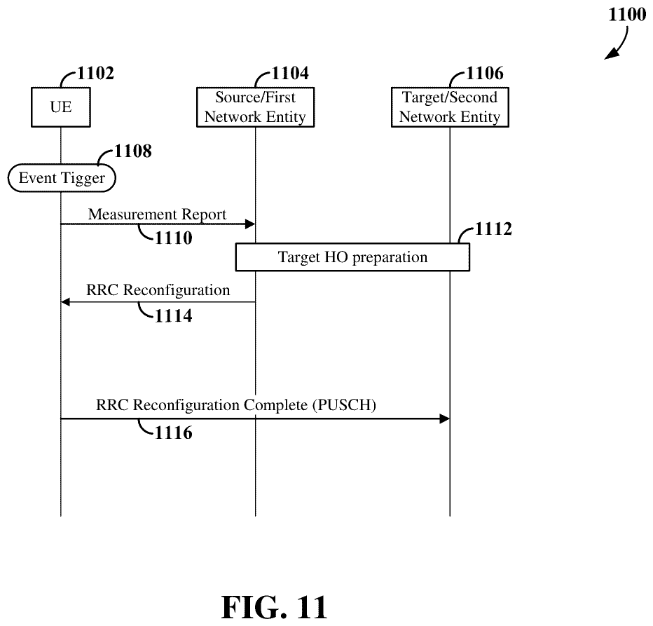

FIG. 11 is a signaling diagram 1100 illustrating an example of signaling associated with a RACH-based handover in a wireless communication system including a user equipment 1102, a first network entity 1104 (e.g., a source gNB), and a second network entity 1106 (e.g., a target gNB). In some examples, the user equipment 1102 may correspond to any of the UEs or scheduled entities shown in any of FIGS. 1-4, 7-10, 12, 14-16, 18, 24, 29, and 30. In some examples, the first network entity 1104 and the second network entity 1106 may correspond to any of the network entities, base stations, CUs, DUs, RUs, or scheduling entities shown in any of FIGS. 1-4, 7-10, 12, 14-16, 21, 24, 29, and 30.

At #1108 of FIG. 11, an event trigger may cause the user equipment 1102 to generate a measurement report (e.g., a measurement report message) and transmit the measurement report at #1110. For example, based on measurements of signals from the first network entity 1104 and one or more other network entities, the user equipment 1102 may determine that a measured signal falls below or above a particular threshold. Examples of event triggers used in 3GPP-based systems include Event A1 (serving cell>threshold), Event A2 (serving cell<threshold), Event A3 (neighbor cell>threshold+offset), Event A4 (neighbor cell>threshold), Event A5 (SpCell<threshold1 and neighbor cell>threshold2), and Event A6 (neighbor cell>SpCell+offset). Other event triggers may be used in other examples.

At #1112, based on the measurement report, the first network entity 1104 may elect to handover the user equipment to the second network entity 1106. Thus, the first network entity 1104 and the second network entity 1106 may cooperate to prepare the second network entity 1106 as the target for handover of the user equipment 1102.

At #1114, the first network entity 1104 sends an RRC reconfiguration message to the user equipment 1102 to inform the user equipment 1102 that it is being handed-over to the second network entity 1106. In some aspects, this RRC reconfiguration message may be referred to as (or referred to as including) a cell switch command.

At #1116, upon receiving the RRC configuration message, the user equipment 1102 sends an RRC reconfiguration complete message to the second network entity 1106 without conducting the RACH procedure. The user equipment 1102 may thereby establish the connection with the second network entity 1106 more quickly as compared to a RACH-based handover.

The disclosure relates in some aspects to mobility procedures. Mobility procedures may include, for example, procedures relating to a beam switch, handover to a cell, and so on.

In some examples, a UE may encounter two types of mobility: cell-level mobility and beam-level mobility (which may be beam-based mobility). For cell-level mobility, a UE may experience an inter-base station handover. In some wireless communication systems, for beam-level mobility, as explained herein, switching of beams may occur within the same base station.

In response to different conditions, beams may be switched. For example, a transmission configuration indication (TCI) state change may be transmitted by a base station so that the UE may switch to a new beam for the TCI state. The TCI state change may cause the UE to find the best UE receive beam corresponding to the TCI state from the base station, and switch to this beam. Switching beams may allow for enhanced or improved connection between the UE and the base station by ensuring that the transmitter and receiver use the same configured set of beams for communication. As used herein, the term “beam” may refer to a spatial filter associated with a transmission.

A TCI state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL reference signals (RSs) in one RS set and PDSCH/PDCCH DM-RS ports. TCI states can provide information about different beam selections for the UE to use for transmitting/receiving various signals. Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for channel quality information (CQI) management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS.

As another example, a spatial relation change, such as a spatial relation update, may trigger the UE to switch beams. Beamforming may be applied to uplink channels, such as but not limited to PUCCH. Beamforming may be based on configuring one or more spatial relations between the uplink and downlink signals. Spatial relation may indicate that a UE may transmit the uplink signal using the same beam as it used for receiving the corresponding downlink signal.

Different procedures for managing and controlling beam may be collectively referred to as “beam management.” The process of selecting a beam to switch to for data channels or control channels may be referred to as “beam selection.” In some wireless communication systems, beam selection for data channels or control channels may be performed for beams within the same physical cell identifier (ID) (PCI).

In some wireless communication systems, inter-cell beam management may be based on beam-based mobility where the indicated beam may be from a TRP that is associated with a PCI that is different from a PCI associated with the serving cell. Benefits of inter-cell beam management based on beam-based mobility may include more robustness against blocking, more opportunities for higher rank for subscriber data management (SDM) across different cells, and in general more efficient communication between a UE and the network.

In some wireless communication systems (e.g., 3GPP NR Release 18), mobility (e.g., including handover procedures) may be based on Layer 1 (physical layer) and Layer 2 (e.g., MAC layer) signaling. Conventionally, Layer 1 may be referred to as L1 and Layer 2 may be referred to as L2. In some aspects, such L1/L2 based mobility may be applicable to any of the following scenarios. L1/L2 mobility may involve a standalone mode of operation, a carrier aggregation (CA) mode of operation, or an NR-DC mode of operation, where there is a serving cell change within one CG. L1/L2 mobility may involve an intra-DU case or an intra-CU-inter-DU case (applicable for standalone and CA). L1/L2 mobility may involve intra-frequency or inter-frequency operation. L1/L2 mobility may involve a FR1 or FR2 operation. L1/L2 mobility may involve scenarios whether the source and target cells are synchronized or non-synchronized. Other scenarios as possible in other examples.

As an example, inter-cell beam management based on beam-based mobility may be facilitated by L1 and/or L2 (referred to as “L1/L2” herein) signaling such as UE-dedicated channels/RSs. This mobility may be associated with a switch to a TRP with a different PCI according to downlink control information (DCI) or a medium access control (MAC) control element (MAC-CE) based unified TCI update. As used herein, such mobility may be referred to as L1/L2 mobility.

In some wireless communication systems, a PCell change using L1/L2 signaling is not supported. A UE may be in the coverage of the serving cell when communicating with TRPs with different PCIs (no support for a serving cell change).

In some aspects, the network may configure a set of cells for L1/L2 mobility. The set of cells for L1/L2 mobility may be referred to as a “L1/L2 mobility configured cell set” or a “mobility configured cell set.” The L1/L2 mobility configured cell set may include an “L1/L2 mobility activated cell set” (which may also be referred to as a “L1/L2 activated mobility cell set,” or a “mobility activated cell set”) and an “L1/L2 mobility deactivated cell set” (which may also be referred to as a “deactivated L1/L2 mobility cell set,” or a “mobility deactivated cell set”). The L1/L2 mobility activated cell set may be a group of cells in the L1/L2 mobility configured cell set that are activated and may be readily used for data and control transfer. The L1/L2 mobility deactivated cell set (which may be a L1/L2 mobility candidate cell set) may be a group of cells in the configured set that are configured for the UE for L1/L2 mobility that may be activated by L1/L2 signaling. Once activated, a deactivated cell may be used for data and control transfer.

For mobility management of the activated cell set, L1/L2 signaling may be used to activate/deactivate cells in the L1/L2 mobility configured cell set and to select beams within the activated cells (of the activated cell set). As the UE moves, cells from the L1/L2 mobility configured cell set may be deactivated and activated by L1/L2 signaling based on signal quality (e.g., based on measurements), loading, or the like. Example measurements may include cell coverage measurements represented by reference signal received power (RSRP), and quality represented by reference signal received quality (RSRQ), or other measurements that the UE performs on signals from the base station. In some aspects, the measurements may be L1 measurements or L2 measurements such as one or more of an RSRP, an RSRQ, a received signal strength indicator (RSSI), or a signal-to-interference and noise ratio (SINR) measurement of various signals, such as a SSB, a PSS, an SSS, a broadcast channel (BCH), a DM-RS, CSI-RS, or the like.

In some examples, cells in an L1/L2 mobility configured cell set may belong to the same DU and the cells may be on the same or different carrier frequencies. Cells in the L1/L2 mobility configured cell set may cover a mobility area.

As a UE moves, a special cell (SpCell) may be reselected or updated among a set of configured candidate SpCells based on the UE's measurements (e.g., L1 measurements such as RSRP, RSRQ, RSSI, SINR, or the like) for the candidate cells. An SpCell may be a primary cell (PCell) or a primary secondary cell (PSCell).

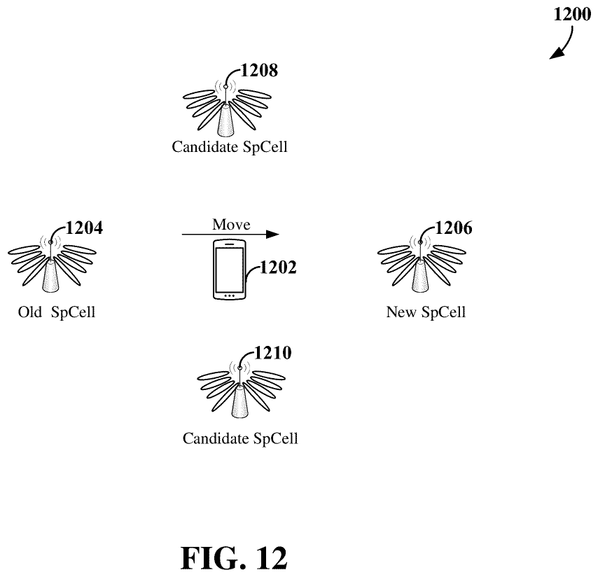

FIG. 12 is a diagram 1200 illustrating an example of movement of a UE and associated switching of an SpCell based on a configured candidate SpCell set. As used herein, the term “candidate SpCell” may refer to a cell configured for a UE that may be activated or switched to as a SpCell for the UE based on L1 or L2 signaling or based on L1 or L2 measurement.

In some examples, the diagram 1200 may illustrate L1/L2 based inter-cell mobility illustrating a single SpCell change (without carrier aggregation) for a UE 1202 via L1/L2 signaling based on L1 measurements. In the example of FIG. 12, the UE 1202 is initially served by an SpCell 1204. In addition, a set of candidate SpCells (e.g., including candidate SpCell 1206, candidate SpCell 1208, and candidate SpCell 1210) may be preconfigured for the UE 1202.

As the UE 1202 moves, the UE 1202 may update its SpCell from the old SpCell 1204 to one of the candidate SpCells in the configured candidate SpCell set including the candidate SpCell 1206, the candidate SpCell 1208, and the candidate SpCell 1210. The configured candidate SpCell set may be configured before the UE moves. The candidate SpCells may be activated before being selected as a new SpCell or may be deactivated before being selected as a new SpCell. In some aspects, each of the candidate SpCell 1206, the candidate SpCell 1208, and the candidate SpCell 1210 may be associated with the same frequency or different frequencies. For example, the candidate SpCell 1206 may be associated with a first frequency, the candidate SpCell 1208 may be associated with a second frequency, and the candidate SpCell 1208 may be associated a third frequency. For example, the other cells sharing the timing advance group (TAG) 1 with the candidate SpCell 1206 may include candidate SpCells and SCells in a candidate cell group associated with a physical cell site associated with the candidate SpCell 1206. In some examples, the UE 1202 may correspond to any of the UEs or scheduled entities shown in any of FIGS. 1-4, 8-11, 14-16, 18, 24, 29, and 30. In some examples, the candidate SpCell 1206, the candidate SpCell 1208, and candidate SpCell 1210 may correspond to any of the network entities, base stations, CUs, DUs, RUs, or scheduling entities shown in any of FIGS. 1-4, 8-11, 14-16, 21, 24, 29, and 30.

Based on measurements of the candidate SpCells by the UE 1202, the UE may be handed over to the candidate SpCell 1206. In some aspects, the candidate SpCell and SCells in the candidate cell group associated with a physical cell site associated with the candidate SpCell 1206 may not be activated until the candidate SpCell 1206 is activated and selected as a new SpCell.

When L1/L2 mobility is used, a UE that is connected to a serving SpCell may also obtain configuration information about candidate SpCells from the serving cell of the UE. Based on this configuration information, the UE may transmit and receive information to and from these candidate SpCells. For example, a UE may conduct measurements of candidate SpCells and select a target SpCell using the L1/L2 signaling. By using L1/L2 signaling, handover latency may be reduced as compared to L3 handover.

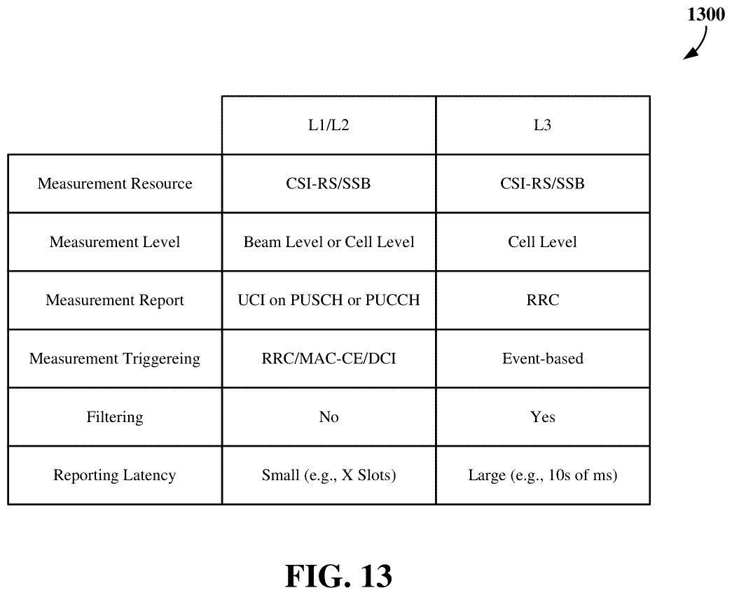

FIG. 13 depicts a table 1300 that describes some of the differences that may exist between L3 mobility and L1/L2 mobility. Of note, for L1/L2 mobility, measurement may be conducted at the beam level. In addition, a measurement report may be sent via uplink control information, which may involve less delay than the RRC signaling used in L3 mobility. Furthermore, L1/L2 measurements may be triggered by RRC signaling, MAC-CE-signaling, or DCI signaling, which further reduce handover latency as compared to L3 mobility which uses event-based triggering. Also, filtering of multiple measurements need not be performed for L1/L2 mobility (e.g., an L1 measurement may be conducted for a single time location), which can further reduce the handover latency as compared to L3 mobility which uses filtering. Also, a UE may have a dedicated CSI report configuration for L1 measurements, where the CSI report configuration is associated with the physical layer.

The disclosure relates in some aspects to techniques using HARQ-less handover in an L1/L2 mobility scenario. By eliminating HARQ signaling, handover latency may be further reduced.

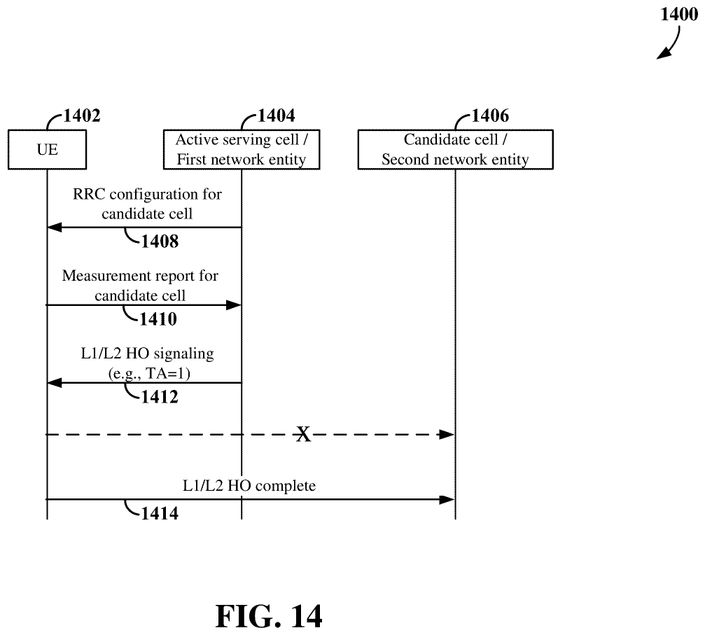

FIG. 14 is a signaling diagram 1400 illustrating an example of signaling associated with a RACH-less L1/L2 handover in a wireless communication system including a user equipment 1402, a first network entity 1404 (e.g., associated with an active serving cell), and a second network entity 1406 (e.g., associated with a candidate cell). In some examples, the user equipment 1402 may correspond to any of the UEs or scheduled entities shown in any of FIGS. 1-4, 7-12, 15-16, 18, 24, 29, and 30. In some examples, the first network entity 1404 and the second network entity 1406 may correspond to any of the network entities, base stations, CUs, DUs, RUs, or scheduling entities shown in any of FIGS. 1-4, 7-12, 15-16, 21, 24, 29, and 30.

At #1408 of FIG. 14, the first network entity 1404 sends an RRC configuration message to the user equipment 1402, where the RRC configuration message includes configuration information about one or more candidate cells for potential handover of the user equipment 1402. In some examples, the configuration information may indicate resources and other parameters used by each candidate cell for transmitting information (e.g., CSI-RS, SSBs, etc.) and receiving information (e.g., SRSs, etc.).

At #1410, based on the configuration information, the user equipment 1402 may conduct signal measurements, generate a measurement report (e.g., a beam report), and transmit the measurement report to the first network entity 1404.

At #1412, based on the measurement report, the first network entity 1404 may elect to handover the user equipment to the second network entity 1406. Thus, the first network entity 1404 sends a L1/L2 handover message to the user equipment 1402 to inform the user equipment 1402 that it is being handed-over to the second network entity 1406. In some aspects, this L1/L2 handover message may be referred to as (or referred to as including) a cell switch command. In some examples, the L1/L2 handover message may include an indication of the timing advance value to be used by the user equipment 1402 when communicating with the second network entity 1406. In some examples, the L1/L2 handover message may be implemented using MAC-CE signaling. In some examples, the L1/L2 handover message may be implemented using DCI signaling.

In this case, the user equipment 1402 does not send a PRACH message to the second network entity 1406 (as represented by the X'ed out dashed line in FIG. 14). Instead, at #1414, upon receiving the L1/L2 handover message, the user equipment 1402 sends an L1/L2 handover complete message to the second network entity 1406. The user equipment 1402 may thereby establish the connection with the second network entity 1406 more quickly as compared to a RACH-based handover. In some examples, the L1/L2 handover complete message may be implemented using MAC-CE signaling. In some examples, the L1/L2 handover complete message may be implemented using DCI signaling.

RACH-less handover may thus be used for a handover to a candidate cell in L1 and L2 mobility. For example, RACH-less handover may be supported for 3GPP R18 L1/L2 mobility whereby, after receiving a cell switching command, a UE may start an uplink (UL) transmission without first transmitting a PRACH message.

### Candidate Cell Measurement

The disclosure relates in some aspects to techniques for supporting L1 measurements based on reference signals (e.g., CSI-RS or SSB) for a candidate cell in L1/L2 based mobility. In some aspects, a UE may be configured for such measurements based on the capability of the UE. In some examples, these measurements may be performed in conjunction with the beam reporting discussed below.

In some examples, certain allowed measurement types are defined per measurement metric. For example, based on UE capability, L1 intra-frequency CSI-RS and/or SSB measurements can be configured and/or inter frequency CSI-RS and/or SSB measurements can be configured. For L1 inter-frequency CSI-RS and/or SSB measurements, a metric to be reported may include one or more of L1 reference signal received power (L1-RSRP), L1 reference signal received quality (L1-RSRQ), L1 signal-to-interference-and-noise ratio (L1-SINR), channel quality information (CQI), rank information, strongest layer indication, or precoding matrix information, in some examples. For L1 intra-frequency CSI-RS and/or SSB measurements, a metric to be reported may include one or more of L1-RSRP, L1-SINR, or CQI.

A reported metric may be based on different types of measurements. In some examples (e.g., where a UE conducts L1 beam-level measurements), a reported metric may correspond to a beam level. In some examples (e.g., where a UE conducts L1 cell-level measurements), a reported metric may correspond to a cell level, which may be a linear average over multiple beams in the cell.

For an L1 intra-frequency signal-to-interference-and-noise ratio (SINR) report, a serving cell may configure a UE with resources that enable the UE to measure a channel and associated interference. For example, a UE may be configured with multiple resource sets, such as a channel measurement resource (CMR) set and one or more interference measurement resource (IMR) sets (e.g., a CMR set may be associated with one or more IMR sets). In various examples, such a CMR may be periodic, semi-persistent, or aperiodic. In various examples, such an IMR may be periodic, semi-persistent, or aperiodic.

For an L1 intra-frequency reference signal received power (RSRP) report, a serving cell may configure a UE with resources that enable the UE to measure a channel. For example, a UE may be configured with one or more resource sets, depending on the type of measurements being conducted. In some examples, a UE may be configured with a channel measurement resource (CMR) set for single TRP operation (e.g., measuring signals from a single TRP). In some examples, a UE may be configured with multiple (e.g., two) CMR sets for a multiple TRP operation (e.g., measuring signals from two or more TRPs). In various examples, such a CMR may be periodic, semi-persistent, or aperiodic.

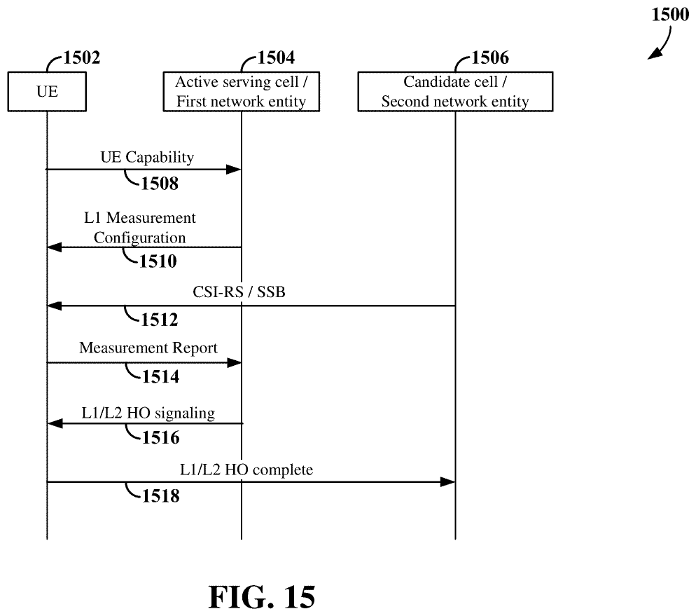

FIG. 15 is a signaling diagram 1500 illustrating an example of measurements associated with an L1/L2 handover (e.g., RACH-less L1/L2 handover) in a wireless communication system including a user equipment 1502, a first network entity 1504 (e.g., the active serving cell), and a second network entity 1506 (e.g., a candidate cell). In some examples, the user equipment 1502 may correspond to any of the UEs or scheduled entities shown in any of FIGS. 1-4, 7-12, 14, 16, 18, 24, 29, and 30. In some examples, the first network entity 1504 and the second network entity 1506 may correspond to any of the network entities, base stations, CUs, DUs, RUs, or scheduling entities shown in any of FIGS. 1-4, 7-12, 14, 16, 21, 24, 29, and 30.

At #1508 of FIG. 15, the user equipment 1502 sends UE capability information to the first network entity 1504 (e.g., via a UE capabilities message). In some examples, the UE capability information may indicate the UE's capabilities with respect to measuring inter-frequency resources, measuring intra-frequency resources, and reporting different types of measurement metrics.

At #1510, the first network entity 1504 sends a L1 measurement configuration message to the user equipment 1502, where the L1 measurement configuration message includes configuration information about one or more candidate cells for potential handover of the user equipment 1502. In some examples, the configuration information may indicate resources and other parameters used by each candidate cell for transmitting information (e.g., CSI-RS, SSBs, etc.) and receiving information (e.g., SRSs, etc.).

At #1512, based on the configuration information received at #1510, the user equipment 1502 may conduct measurements of signals transmitted by the second network entity 1506. For example, the user equipment 1502 may measure CSI-RS signaling on configured CSI-RS resources and/or measure SSB signaling on configured SSB resources.

At #1514, based on the measurements of #1512, the user equipment 1502 generates a measurement report (e.g., a beam report), and transmits the measurement report to the first network entity 1504.

Based on the measurement report, the first network entity 1504 may elect to handover the user equipment to the second network entity 1506. Thus, at #1516, the first network entity 1504 sends a L1/L2 handover message to the user equipment 1502 to inform the user equipment 1502 that it is being handed-over to the second network entity 1506. In some aspects, this L1/L2 handover message may be referred to as including a cell switch command. In some examples, the L1/L2 handover message may include an indication of the timing advance value to be used by the user equipment 1502 when communicating with the second network entity 1506. In some examples, the L1/L2 handover message may be implemented using MAC-CE signaling. In some examples, the L1/L2 handover message may be implemented using DCI signaling.

At #1518, upon receiving the L1/L2 handover message, the user equipment 1502 completes the handover, sending an L1/L2 handover complete message to the second network entity 1506 as discussed above.

The disclosure relates in some aspects to techniques for supporting LI UL measurement based on a SRS for a candidate cell in L1/L2 based mobility. In some examples, SRS frequency options may be based on UE capability. For example, based on UE capability, an L1 intra-frequency SRS or an L1 inter-frequency SRS can be configured. An SRS for a candidate cell can be indicated to transmit periodically, semi-persistently, or aperiodically.

In the case of inter-frequency SRS, the SRS for a candidate cell may use one or more parameters (e.g., UL or SRS parameters) that are different from the parameters used by the active serving cell. For example, the candidate cell may use one or more of a different center frequency, a different sub-carrier spacing (SCS), or a different bandwidth part (BWP) as compared to the serving cell.

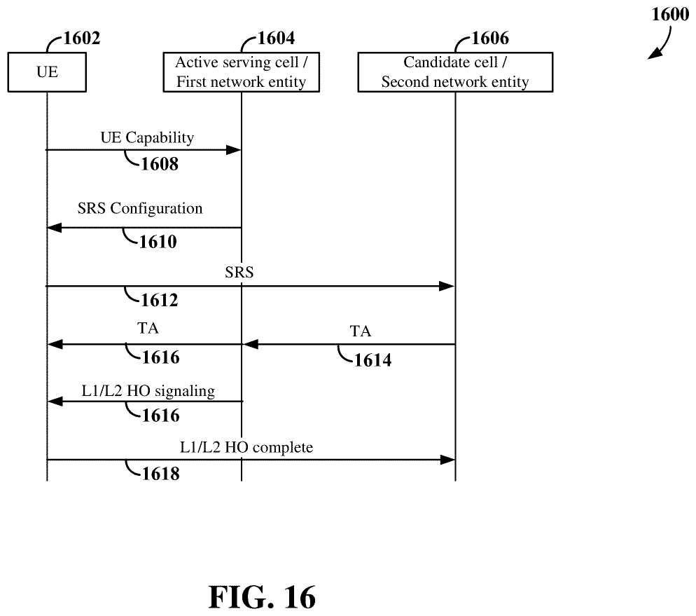

FIG. 16 is a signaling diagram 1600 illustrating an example of SRS transmissions associated with an L1/L2 handover (e.g., a RACH-less L1/L2 handover) in a wireless communication system including a user equipment 1602, a first network entity 1604 (e.g., the active serving cell), and a second network entity 1606 (e.g., a candidate cell). In some examples, the user equipment 1602 may correspond to any of the UEs or scheduled entities shown in any of FIGS. 1-4, 7-12, 14-15, 18, 24, 29, and 30. In some examples, the first network entity 1604 and the second network entity 1606 may correspond to any of the network entities, base stations, CUs, DUs, RUs, or scheduling entities shown in any of FIGS. 1-4, 7-12, 14-15, 21, 24, 29, and 30.

At #1608 of FIG. 16, the user equipment 1602 sends UE capability information to the first network entity 1604 (e.g., via a UE capabilities message). In some examples, the UE capability information may indicate the UE's capabilities with respect to transmitting an inter-frequency SRS, transmitting an intra-frequency SRS, and guard time requirements.

At #1610, the first network entity 1604 sends an SRS configuration message to the user equipment 1602, where the SRS configuration message includes configuration information about one or more candidate cells for potential handover of the user equipment 1602. In some examples, the configuration information may indicate resources and other parameters used by each candidate cell for receiving information (e.g., SRSs, etc.).

At #1612, based on the configuration information received at #1610, the user equipment 1602 may transmit an SRS to the second network entity 1606. For example, the SRS configuration message received at #1610 may instruct the user equipment 1602 to transmit this SRS.

At #1614, the second network entity 1606 generates timing advance (TA) information based on the SRS received at #1612 and transmits the TA information to the first network entity 1604. Then, at #1616, the first network entity 1604 forwards the TA information to the user equipment 1602.

As discussed above, the user equipment conduct L1 measurements, generates a measurement report (e.g., a beam report), and transmits the measurement report to the first network entity 1604. Based on the measurement report, the first network entity 1604 may elect to handover the user equipment to the second network entity 1606. Thus, at #1616, the first network entity 1604 sends a L1/L2 handover message to the user equipment 1602 to inform the user equipment 1602 that it is being handed-over to the second network entity 1606. In some examples, the L1/L2 handover message may be implemented using MAC-CE signaling. In some examples, the L1/L2 handover message may be implemented using DCI signaling.

At #1618, upon receiving the L1/L2 handover message, the user equipment 1602 completes the handover, sending an L1/L2 handover complete message to the second network entity 1606. As discussed herein, this uplink signaling may be based on the TA information received at #1616.

The disclosure relates in some aspects to the use of a guard time for SRS transmissions. In some examples, a UE is not expected to transmit or receive (e.g., transmit a PUCCH, a PUSCH, or an SRS, or receive a PDCCH, a PDSCH or a CSI-RS for tracking or a CSI-RS for CQI) on SRS symbols for an L1 UL measurement. In addition, the UE may not be expected to transmit on X data symbols before each SRS symbol for an LI UL measurement and X data symbols after each SRS symbol for an L1 UL measurement. In some examples, X is a fixed value. In some examples, X is a UE capability. In some examples, the symbol duration may be based on the SCS of the active serving cell or the SCS of the candidate cell. The above rules may apply to at least inter-frequency SRS. In some examples, the guard time may be reserved for RF tuning.

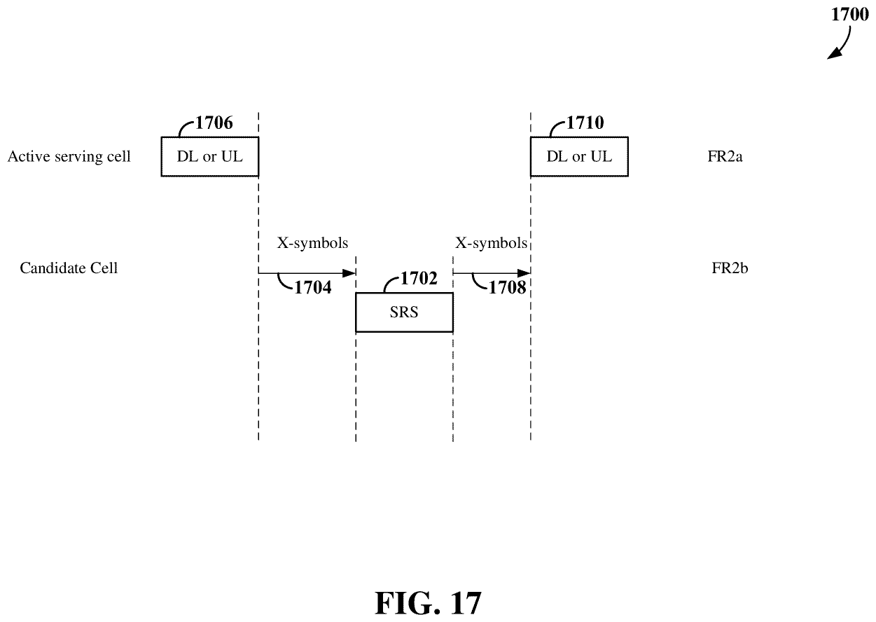

FIG. 17 depicts a timing diagram 1700 that illustrates guard times for an SRS transmission 1702. In this example, a first guard time 1704 is defined between the end of a DL reception or an UL transmission 1706 and the beginning of the SRS transmission 1702. In addition, a second guard time 1708 is defined between the end of the SRS transmission 1702 and the beginning of a DL reception or an UL transmission 1710.

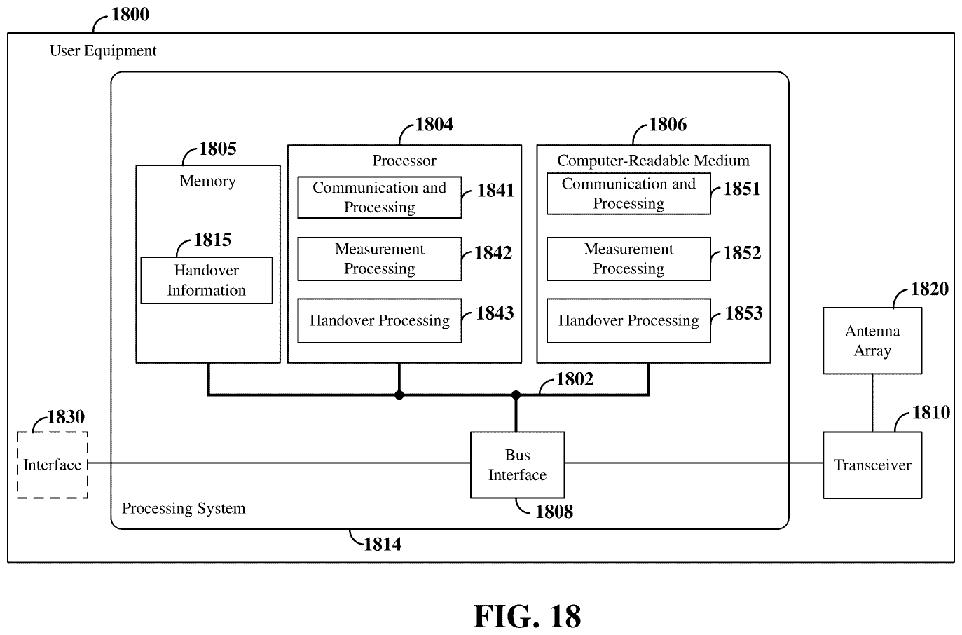

FIG. 18 is a block diagram illustrating an example of a hardware implementation for a UE 1800 employing a processing system 1814. For example, the UE 1800 may be a device configured to wirelessly communicate with a network entity, as discussed in any one or more of FIGS. 1-17 and 19-30. In some implementations, the UE 1800 may correspond to any of the UEs or scheduled entities shown in any of FIGS. 1-4, 7-12, 14-16, 24, 29, and 30.

In accordance with various aspects of the disclosure, an element, or any portion of an element, or any combination of elements may be implemented with the processing system 1814. The processing system 1814 may include one or more processors (referred to herein as the processor 1804, for convenience). Examples of processors 1804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 1800 may be configured to perform any one or more of the functions described herein. That is, the processor 1804, as utilized in a UE 1800, may be used to implement any one or more of the processes and procedures described herein.

The processor 1804 may in some instances be implemented via a baseband or modem chip and in other implementations, the processor 1804 may include a number of devices distinct and different from a baseband or modem chip (e.g., in such scenarios as may work in concert to achieve the examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1814 may be implemented with a bus architecture, represented generally by the bus 1802. The bus 1802 may include any number of interconnecting buses and bridges depending on the specific application of the processing system 1814 and the overall design constraints. The bus 1802 communicatively couples together various circuits including one or more processors (represented generally by the processor 1804), one or more memories (referred to herein as the memory 1805, for convenience), and one or more computer-readable media (represented generally by the computer-readable medium 1806). The memory 1805 and/or the computer-readable medium 1806 may store processor-executable code for the processor 1804. The bus 1802 may also link various other circuits such as timing sources, peripherals, voltage regulators, and power management circuits, which are well known in the art, and therefore, will not be described any further. A bus interface 1808 provides an interface between the bus 1802, a transceiver 1810 and an antenna array 1820 and between the bus 1802 and an interface 1830. The transceiver 1810 provides a communication interface or means for communicating with various other apparatus over a wireless transmission medium. The interface 1830 provides a communication interface or means of communicating with various other apparatuses and devices (e.g., other devices housed within the same apparatus as the UE 1800 or other external apparatuses) over an internal bus or external transmission medium, such as an Ethernet cable. Depending upon the nature of the apparatus, the interface 1830 may include a user interface (e.g., keypad, display, speaker, microphone, joystick). Of course, such a user interface is optional, and may be omitted in some examples, such as an IoT device.

The processor 1804 is responsible for managing the bus 1802 and general processing, including the execution of software stored on the computer-readable medium 1806. The software, when executed by the processor 1804, causes the processing system 1814 to perform the various functions described below for any particular apparatus. The computer-readable medium 1806 and the memory 1805 may also be used for storing data that is manipulated by the processor 1804 when executing software. For example, the memory 1805 may store handover information 1815 (e.g., measurement information) used by the processor 1804 for the communication operations described herein.

One or more processors 1804 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 1806.

The computer-readable medium 1806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1806 may reside in the processing system 1814, external to the processing system 1814, or distributed across multiple entities including the processing system 1814. The computer-readable medium 1806 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

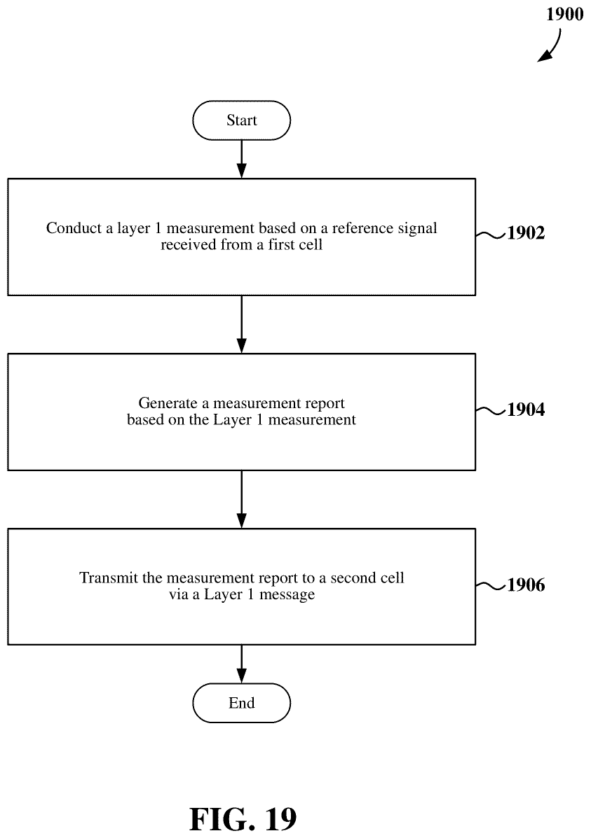

The UE 1800 may be configured to perform any one or more of the operations described herein (e.g., as described in conjunction with FIGS. 19, 20, 25, and 26, and elsewhere). In some aspects of the disclosure, the processor 1804, as utilized in the UE 1800, may include circuitry configured for various functions.

The processor 1804 may include communication and processing circuitry 1841. The communication and processing circuitry 1841 may be configured to communicate with a network entity, such as a gNB. The communication and processing circuitry 1841 may be configured to communicate with a base station and one or more other wireless communication devices over a common carrier shared between a cellular (e.g., Uu) interface and a sidelink (e.g., PC5) interface. The communication and processing circuitry 1841 may include one or more hardware components that provide the physical structure that performs various processes related to wireless communication (e.g., signal reception and/or signal transmission) as described herein. The communication and processing circuitry 1841 may further include one or more hardware components that provide the physical structure that performs various processes related to signal processing (e.g., processing a received signal and/or processing a signal for transmission) as described herein. In some examples, the communication and processing circuitry 1841 may include two or more transmit/receive chains (e.g., one chain to communicate with a base station and another chain to communicate with a sidelink device). The communication and processing circuitry 1841 may further be configured to execute communication and processing software 1851 included on the computer-readable medium 1806 to implement one or more functions described herein.

In some implementations where the communication involves receiving information, the communication and processing circuitry 1841 may obtain information from a component of the UE 1800 (e.g., from the transceiver 1810 that receives the information via radio frequency signaling or some other type of signaling suitable for the applicable communication medium), process (e.g., decode) the information, and output the processed information. For example, the communication and processing circuitry 1841 may output the information to another component of the processor 1804, to the memory 1805, or to the bus interface 1808. In some examples, the communication and processing circuitry 1841 may receive one or more of signals, messages, other information, or any combination thereof. In some examples, the communication and processing circuitry 1841 may receive information via one or more channels. In some examples, the communication and processing circuitry 1841 may receive one or more of signals, messages, SCIs, feedback, other information, or any combination thereof. In some examples, the communication and processing circuitry 1841 may receive information via one or more of a PSCCH, a PSSCH, a PSFCH, some other type of channel, or any combination thereof. In some examples, the communication and processing circuitry 1841 may include functionality for a means for receiving. In some examples, the communication and processing circuitry 1841 may include functionality for a means for decoding.

In some implementations where the communication involves sending (e.g., transmitting) information, the communication and processing circuitry 1841 may obtain information (e.g., from another component of the processor 1804, the memory 1805, or the bus interface 1808), process (e.g., encode) the information, and output the processed information. For example, the communication and processing circuitry 1841 may output the information to the transceiver 1810 (e.g., that transmits the information via radio frequency signaling or some other type of signaling suitable for the applicable communication medium). In some examples, the communication and processing circuitry 1841 may send one or more of signals, messages, other information, or any combination thereof. In some examples, the communication and processing circuitry 1841 may send information via one or more channels. In some examples, the communication and processing circuitry 1841 may send one or more of signals, messages, SCIs, feedback, other information, or any combination thereof. In some examples, the communication and processing circuitry 1841 may send information via one or more of a PSCCH, a PSSCH, a PSFCH, some other type of channel, or any combination thereof. In some examples, the communication and processing circuitry 1841 may include functionality for a means for transmitting. In some examples, the communication and processing circuitry 1841 may include functionality for a means for encoding.

The processor 1804 may include measurement processing circuitry 1842 configured to perform measurement processing-related operations as discussed herein (e.g., one or more of the measurement operations described herein in conjunction with FIGS. 1-17, 19-20, and 24-26). The measurement processing circuitry 1842 may be configured to execute measurement processing software 1852 included on the computer-readable medium 1806 to implement one or more functions described herein.

The measurement processing circuitry 1842 may include functionality for a means for receiving (e.g., one or more of the receive operations described herein in conjunction with FIGS. 1-17, 19-20, and 24-26). For example, the measurement processing circuitry 1842 may cooperate with the communication and processing circuitry 1841 to receive a measurement report configuration from a network entity (e.g., via RRC signaling). As another example, the measurement processing circuitry 1842 may cooperate with the communication and processing circuitry 1841 to receive a message from a network entity (e.g., via a PDSCH or a PDCCH). As a further example, the measurement processing circuitry 1842 may cooperate with the communication and processing circuitry 1841 to receive a handover command from a network entity. As another example, the measurement processing circuitry 1842 may cooperate with the communication and processing circuitry 1841 to receive a MAC-CE and/or DCI from a network entity.

The measurement processing circuitry 1842 may include functionality for a means for conducting a measurement (e.g., one or more of the Layer 1 measurement operations described herein in conjunction with FIGS. 1-17, 19-20, and 24-26). For example, the measurement processing circuitry 1842 may cooperate with the communication and processing circuitry 1841 to measure (e.g., aperiodically measure and/or periodically measure) reference signals (e.g., SSB signals, a TRS, a CSI-RS, etc.) transmitted by a cell (e.g., an SCell). As another example, the measurement processing circuitry 1842 may cooperate with the communication and processing circuitry 1841 to perform measurements. As a further example, the measurement processing circuitry 1842 may cooperate with the communication and processing circuitry 1841 to acquire SSB information from an SSB signal. As another example, the measurement processing circuitry 1842 may cooperate with the communication and processing circuitry 1841 to perform CSI-RS measurements.

The measurement processing circuitry 1842 may include functionality for a means for generating a measurement report (e.g., one or more of the report generation operations described herein in conjunction with FIGS. 1-17, 19-20, and 24-26). For example, the measurement processing circuitry 1842 may generate a measurement report (e.g., a measurement report message) based on Layer 1 measurements (e.g., CSI-RS measurements, SSB measurements, etc.). The report may include, for example, reference signal received power (RSRP) metrics and/or other metrics.

The measurement processing circuitry 1842 may include functionality for a means for transmitting (e.g., one or more of the transmit operations described herein in conjunction with FIGS. 1-17, 19-20, and 24-26). For example, the measurement processing circuitry 1842 may cooperate with the communication and processing circuitry 1841 to transmit (e.g., aperiodically transmit and/or periodically transmit) a measurement report (e.g., a measurement report message) to a network entity. As another example, the measurement processing circuitry 1842 may cooperate with the communication and processing circuitry 1841 to transmit a message to a network entity (e.g., via a PUSCH or a PUCCH). As a further example, the measurement processing circuitry 1842 may cooperate with the communication and processing circuitry 1841 to transmit capability information to a network entity.

The processor 1804 may include handover processing circuitry 1843 configured to perform handover processing-related operations as discussed herein (e.g., one or more of the handover operations described herein in conjunction with FIGS. 1-17, 19-20, and 24-26). The handover processing circuitry 1843 may be configured to execute handover processing software 1853 included on the computer-readable medium 1806 to implement one or more functions described herein.

The handover processing circuitry 1843 may include functionality for a means for receiving (e.g., one or more of the receive operations described herein in conjunction with FIGS. 1-17, 19-20, and 24-26). For example, the handover processing circuitry 1843 may cooperate with the communication and processing circuitry 1841 to receive a message (e.g., for a cell addition or a cell activation) from network entity on designated resources. As another example, the handover processing circuitry 1843 may cooperate with the communication and processing circuitry 1841 to receive a handover command from a network entity. As a further example, the handover processing circuitry 1843 may cooperate with the communication and processing circuitry 1841 to receive an SRS configuration from a network entity.

The handover processing circuitry 1843 may include functionality for a means for transmitting a message (e.g., one or more of the transmit operations described herein in conjunction with FIGS. 1-17, 19-20, and 24-26). For example, the handover processing circuitry 1843 may cooperate with the communication and processing circuitry 1841 to transmit a message to a network entity on designated resources. As another example, the handover processing circuitry 1843 may cooperate with the communication and processing circuitry 1841 to transmit an SRS (e.g., transmit an SRS transmission).

The handover processing circuitry 1843 may include functionality for a means for RF tuning (e.g., one or more of the tuning operations described herein in conjunction with FIGS. 1-17, 19-20, and 24-26). For example, the handover processing circuitry 1843 may cooperate with the communication and processing circuitry 1841 to conduct RF tuning during at least one guard time.

FIG. 19 is a flow chart illustrating an example method 1900 for wireless communication in accordance with some aspects of the present disclosure. As described below, some or all illustrated features may be omitted in a particular implementation within the scope of the present disclosure, and some illustrated features may not be required for implementation of all examples. In some examples, the method 1900 (method for wireless communication) may be carried out by the UE 1800 illustrated in FIG. 18. In some examples, the method 1900 may be carried out by any suitable apparatus or means for carrying out the functions or algorithm described below.

At block 1902, a user equipment may conduct a Layer 1 measurement based on a reference signal received from a first cell. In some examples, the measurement processing circuitry 1842 together with the communication and processing circuitry 1841 and the transceiver 1810, shown and described in FIG. 18, may provide a means to conduct a Layer 1 measurement based on a reference signal received from a first cell.

At block 1904, the user equipment may generate a measurement report based on the Layer 1 measurement. In some examples, the measurement processing circuitry 1842, shown and described in FIG. 18, may provide a means to generate a measurement report based on the Layer 1 measurement.

At block 1906, the user equipment may transmit the measurement report to a second cell via a Layer 1 message. In some examples, the measurement processing circuitry 1842 together with the communication and processing circuitry 1841 and the transceiver 1810, shown and described in FIG. 18, may provide a means to transmit the measurement report to a second cell via a Layer 1 message.

In some examples, the Layer 1 message may include (e.g., may be) uplink control information (UCI). In some examples, the reference signal may include a channel state information-reference signal (CSI-RS) or a synchronization signal block (SSB) signal.

In some examples, the user equipment may receive a configuration that specifies at least one first measurement metric for an inter-frequency Layer 1 measurement, and at least one second measurement metric for an intra-frequency Layer 1 measurement. In some examples, the at least one first measurement metric may include at least one of a Layer 1 reference signal received power (L1-RSRP), a Layer 1 reference signal received quality (L1-RSRQ), a Layer 1 signal-to-interference-and-noise ratio (L1-SINR), or channel quality information. In some examples, the at least one second measurement metric may include at least one of a Layer 1 reference signal received power (L1-RSRP), a Layer 1 signal-to-interference-and-noise ratio (L1-SINR), or channel quality information.

In some examples, the measurement report may include a measurement metric associated with a beam-level measurement. In some examples, the measurement report may include a measurement metric associated with a cell-level measurement.

In some examples, the user equipment may receive at least one configuration that specifies at least one first resource for channel measurements, and at least one second resource for interference measurements. In some examples, conducting the Layer 1 measurement may include measuring signal on the at least one first resource and the at least one second resource, and generating the measurement report may include generating a Layer 1 signal-to-interference-and-noise ratio (L1-SINR) measurement metric based on the Layer 1 measurement. In some examples, the at least one first resource may include at least one channel measurement resource (CMR) set. In some examples, the at least one second resource may include at least one interference measurement resource (IMR) set.

In some examples, the CMR set may include at least one of a first periodic resource, a first semi-persistent resource, or a first aperiodic resource. In some examples, the IMR set may include at least one of a second periodic resource, a second semi-persistent resource, or a second aperiodic resource.

In some examples, the user equipment may receive at least one configuration that specifies at least one of a single channel measurement resource (CMR) set for a single transmit receive point (TRP) measurement operation, or multiple CMR sets for a multiple TRP measurement operation. In some examples, conducting the Layer 1 measurement may include measuring at least one signal on the single CMR set or the multiple CMR sets, and the generating the measurement report may include generating at least one Layer 1 reference signal received power (L1-RSRP) measurement metric based on the Layer 1 measurement.

In some examples, the single CMR set may include at least one of a first periodic resource, a first semi-persistent resource, or a first aperiodic resource. In some examples, the multiple CMR sets may include at least one of second periodic resources, second semi-persistent resources, or second aperiodic resources.

In some examples, the user equipment may receive, from the second cell, a cell switch command via a first Layer 1 message or via a first Layer 2 message, the cell switch command identifying the first cell for handover of the user equipment. In some examples, the user equipment may transmit a handover complete message to the first cell in response to the cell switch command, the handover complete message being transmitted via a second Layer 1 message or via a second Layer 2 message.

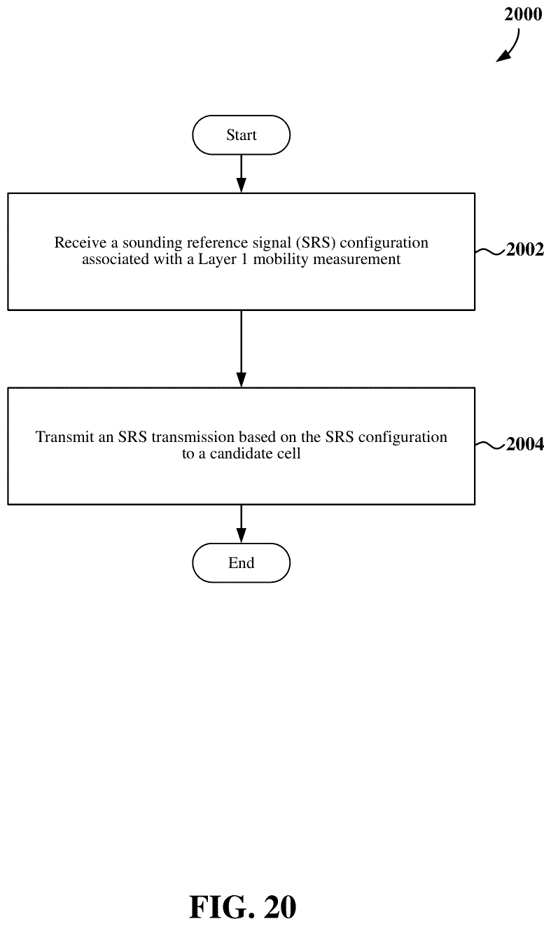

FIG. 20 is a flow chart illustrating an example method 2000 for wireless communication in accordance with some aspects of the present disclosure. As described below, some or all illustrated features may be omitted in a particular implementation within the scope of the present disclosure, and some illustrated features may not be required for implementation of all examples. In some examples, the method 2000 (method for wireless communication) may be carried out by the UE 1800 illustrated in FIG. 18. In some examples, the method 2000 may be carried out by any suitable apparatus or means for carrying out the functions or algorithm described below.

At block 2002, a user equipment may receive a sounding reference signal (SRS) configuration associated with a Layer 1 mobility measurement. In some examples, the measurement processing circuitry 1842 together with the communication and processing circuitry 1841 and the transceiver 1810, shown and described in FIG. 18, may provide a means to receive a sounding reference signal (SRS) configuration associated with a Layer 1 mobility measurement.

At block 2004, the user equipment may transmit an SRS transmission based on the SRS configuration to a candidate cell. In some examples, the measurement processing circuitry 1842 together with the communication and processing circuitry 1841 and the transceiver 1810, shown and described in FIG. 18, may provide a means to transmit an SRS transmission based on the SRS configuration to a candidate cell.

In some examples, the SRS transmission may include (e.g., may be) an inter-frequency SRS transmission. In some examples, the SRS transmission may include an intra-frequency SRS transmission.

In some examples, the SRS configuration specifies that the SRS transmission is to be transmitted periodically, semi-persistently, or aperiodically.

In some examples, the SRS transmission may include a Layer 1 inter-frequency SRS transmission, and the SRS configuration specifies at least one first SRS parameter associated with a serving cell of the user equipment and at least one second SRS parameter associated with the candidate cell. In some examples, the at least one first SRS parameter is different from the at least one second SRS parameter. In some examples, the at least one second SRS parameter may include at least one of a center frequency, a sub-carrier spacing (SCS), or a bandwidth part (BWP).

In some examples, the SRS configuration specifies at least one guard time between the SRS transmission and at least one other communication by the user equipment. In some examples, the at least one guard time specifies at least one of a first quantity of symbols before the SRS transmission, or a second quantity of symbols after the SRS transmission. In some examples, at least one of the first quantity of symbols or the second quantity of symbols is a fixed value. In some examples, at least one of the first quantity of symbols or the second quantity of symbols is based on a capability of the user equipment. In some examples, at least one of the first quantity of symbols or the second quantity of symbols is at least partially based on a first sub-carrier spacing (SCS) of a serving cell of the user equipment, or a second SCS of the candidate cell.

In some examples, the user equipment may conduct radio frequency tuning during the guard time.

In some examples, the user equipment may receive, from a serving cell, a cell switch command via a first Layer 1 message or via a first Layer 2 message, the cell switch command identifying the candidate cell for handover of the user equipment. In some examples, the user equipment may transmit a handover complete message to the candidate cell in response to the cell switch command, the handover complete message being transmitted via a second Layer 1 message or via a second Layer 2 message.

Referring again to FIG. 18, in one configuration, the user equipment 1800 includes means for conducting a Layer 1 measurement based on a reference signal received from a first cell, means for generating a measurement report based on the Layer 1 measurement, and means for transmit the measurement report to a second cell via a Layer 1 message. In one configuration, the user equipment 1800 includes means for receiving a sounding reference signal (SRS) configuration associated with a Layer 1 mobility measurement, and means for transmitting an SRS transmission based on the SRS configuration to a candidate cell. In one aspect, the aforementioned means may be the processor 1804 shown in FIG. 18 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 1804 is merely provided as an example, and other means for carrying out the described functions may be included within various aspects of the present disclosure, including but not limited to the instructions stored in the computer-readable medium 1806, or any other suitable apparatus or means described in any of FIGS. 1-4, 7-12, 14-16, 18, 21, 24, 29, and 30, and utilizing, for example, the methods and/or algorithms described herein in relation to FIGS. 19-20.

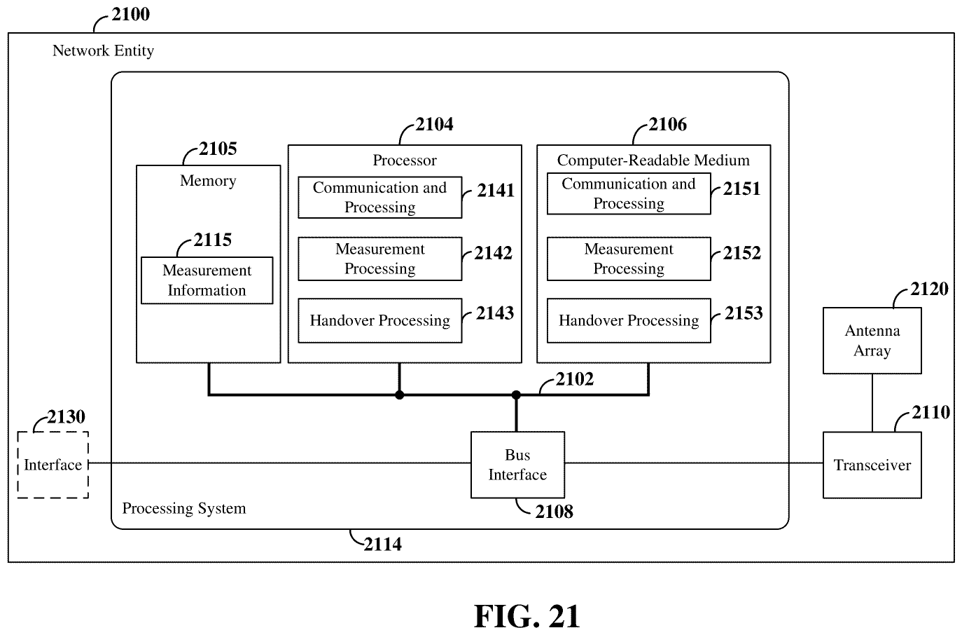

FIG. 21 is a conceptual diagram illustrating an example of a hardware implementation for a network entity 2100 employing a processing system 2114. In some implementations, the network entity 2100 may correspond to any of the base stations, CUs, DUs, RUs, or scheduling entities shown in any of FIGS. 1-4, 7-12, 14-16, 24, 29, and 30.

In accordance with various aspects of the disclosure, an element, or any portion of an element, or any combination of elements may be implemented with the processing system 2114. The processing system may include one or more processors (represented generally by the processor 2104). The processing system 2114 may be substantially the same as the processing system 1814 illustrated in FIG. 18, including a bus interface 2108, a bus 2102, one or more memories (referred to herein as the memory 2105, for convenience), and one or more computer-readable media (represented generally by the computer-readable medium 2106), a transceiver 2110, and an antenna array 2120. The memory 2105 may store handover information 2115 (e.g., measurement information) used by the processor 2104 in cooperation with the transceiver 2110 for communication operations as described herein. The memory 2105 and/or the computer-readable medium 2106 may store processor-executable code for the processor 2104. Furthermore, the network entity 2100 may include an interface 2130 (e.g., a network interface) that provides a means for communicating with at least one other apparatus within a core network and with at least one radio access network.

The network entity 2100 may be configured to perform any one or more of the operations described herein (e.g., one or more of the operations described herein in conjunction with FIGS. 1-17, 22-23, and 27-28). In some aspects of the disclosure, the processor 2104, as utilized in the network entity 2100, may include circuitry configured for various functions.

The processor 2104 may be configured to generate, schedule, and modify a resource assignment or grant of time-frequency resources (e.g., a set of one or more resource elements). For example, the processor 2104 may schedule time-frequency resources within a plurality of time division duplex (TDD) and/or frequency division duplex (FDD) subframes, slots, and/or mini-slots to carry user data traffic and/or control information to and/or from multiple scheduled entities. The processor 2104 may be configured to schedule resources for the transmission of downlink signals. The processor 2104 may further be configured to schedule resources for the transmission of uplink signals.

In some aspects of the disclosure, the processor 2104 may include communication and processing circuitry 2141. The communication and processing circuitry 2141 may be configured to communicate with a user equipment. The communication and processing circuitry 2141 may include one or more hardware components that provide the physical structure that performs various processes related to communication (e.g., signal reception and/or signal transmission) as described herein. The communication and processing circuitry 2141 may further include one or more hardware components that provide the physical structure that performs various processes related to signal processing (e.g., processing a received signal and/or processing a signal for transmission) as described herein. The communication and processing circuitry 2141 may further be configured to execute communication and processing software 2151 included on the computer-readable medium 2106 to implement one or more functions described herein.

The communication and processing circuitry 2141 may further be configured to receive an indication from the UE. For example, the indication may be included in a MAC-CE carried in a Uu PUSCH or a PSCCH, or included in a Uu RRC message or an SL RRC message, or included in a dedicated Uu PUCCH or PUSCH. The communication and processing circuitry 2141 may further be configured to receive a scheduling request from a UE for an uplink grant or a sidelink grant.

In some implementations wherein the communication involves receiving information, the communication and processing circuitry 2141 may obtain information from a component of the network entity 2100 (e.g., from the transceiver 2110 that receives the information via radio frequency signaling or some other type of signaling suitable for the applicable communication medium), process (e.g., decode) the information, and output the processed information. For example, the communication and processing circuitry 2141 may output the information to another component of the processor 2104, to the memory 2105, or to the bus interface 2108. In some examples, the communication and processing circuitry 2141 may receive one or more of signals, messages, other information, or any combination thereof. In some examples, the communication and processing circuitry 2141 may receive information via one or more channels. In some examples, the communication and processing circuitry 2141 may include functionality for a means for receiving. In some examples, the communication and processing circuitry 2141 may include functionality for a means for decoding.

In some implementations wherein the communication involves sending (e.g., transmitting) information, the communication and processing circuitry 2141 may obtain information (e.g., from another component of the processor 2104, the memory 2105, or the bus interface 2108), process (e.g., encode) the information, and output the processed information. For example, the communication and processing circuitry 2141 may output the information to the transceiver 2110 (e.g., that transmits the information via radio frequency signaling or some other type of signaling suitable for the applicable communication medium). In some examples, the communication and processing circuitry 2141 may send one or more of signals, messages, other information, or any combination thereof. In some examples, the communication and processing circuitry 2141 may send information via one or more channels. In some examples, the communication and processing circuitry 2141 may include functionality for a means for transmitting. In some examples, the communication and processing circuitry 2141 may include functionality for a means for encoding.

The processor 2104 may include measurement processing circuitry 2142 configured to perform measurement processing-related operations as discussed herein (e.g., one or more of the operations described herein in conjunction with FIGS. 1-17, 22-23, and 27-28). The measurement processing circuitry 2142 may be configured to execute measurement processing software 2152 included on the computer-readable medium 2106 to implement one or more functions described herein.

The measurement processing circuitry 2142 may include functionality for a means for transmitting (e.g., one or more of the transmit operations described herein in conjunction with FIGS. 1-17, 22-23, and 27-28). For example, the measurement processing circuitry 2142 may cooperate with the communication and processing circuitry 2141 to transmit a measurement report configuration to a UE (e.g., via RRC signaling). As another example, the measurement processing circuitry 2142 may cooperate with the communication and processing circuitry 2141 to transmit a message to a UE (e.g., via a PDSCH or a PDCCH). As a further example, the measurement processing circuitry 2142 may cooperate with the communication and processing circuitry 2141 to transmit a handover command to a UE. As another example, the measurement processing circuitry 2142 may cooperate with the communication and processing circuitry 2141 to transmit a MAC-CE and/or DCI to a UE. As another example, the measurement processing circuitry 2142 may cooperate with the communication and processing circuitry 2141 to transmit a configuration to a UE.

The measurement processing circuitry 2142 may include functionality for a means for receiving (e.g., one or more of the receive operations described herein in conjunction with FIGS. 1-17, 22-23, and 27-28). In some examples, the measurement processing circuitry 2142 may cooperate with the communication and processing circuitry 2141 to receive (e.g., aperiodically receive and/or periodically receive) a measurement report from a UE. For example, the measurement processing circuitry 2142 may receive, from a UE, a measurement report based on RSRP measurements and/or CSI-RS measurements. As another example, the measurement processing circuitry 2142 may cooperate with the communication and processing circuitry 2141 to receive a message from a UE (e.g., via a PUSCH or a PUCCH). As a further example, the measurement processing circuitry 2142 may cooperate with the communication and processing circuitry 2141 to receive capability information from a UE. In some examples, the measurement processing circuitry 2142 may cooperate with the communication and processing circuitry 2141 to receive an SRS from a UE (e.g., via one or more beams).

The processor 2104 may include handover processing circuitry 2143 configured to perform handover processing-related operations as discussed herein (e.g., one or more of the handover operations described herein in conjunction with FIGS. 1-17, 22-23, and 27-28). The handover processing circuitry 2143 may be configured to execute handover processing software 2153 included on the computer-readable medium 2106 to implement one or more functions described herein.

The handover processing circuitry 2143 may include functionality for a means for transmitting a message (e.g., one or more of the transmit operations described herein in conjunction with FIGS. 1-17, 22-23, and 27-28). For example, the handover processing circuitry 2143 may cooperate with the communication and processing circuitry 2141 to transmit a message (e.g., for a cell addition or a cell activation) to a UE on designated resources. As another example, the handover processing circuitry 2143 may cooperate with the communication and processing circuitry 2141 to transmit a handover command to a user equipment. As a further example, the measurement processing circuitry 2142 may cooperate with the communication and processing circuitry 2141 to transmit information based on an SRS (e.g., configuration information) to a UE.

The handover processing circuitry 2143 may include functionality for a means for receiving a message (e.g., one or more of the receive operations described herein in conjunction with FIGS. 1-17, 22-23, and 27-28). For example, the handover processing circuitry 2143 may cooperate with the communication and processing circuitry 2141 to receive a message from a UE on designated resources.

In some examples, the network entity 2100 shown and described above in connection with FIG. 21 may be a disaggregated base station. For example, the network entity 2100 shown in FIG. 21 may include the CU and optionally one or more DUs/RUs of the disaggregated base station. Other DUs/RUs associated with the network entity 2100 may be distributed throughout the network. In some examples, the DUs/RUs may correspond to TRPs associated with the network entity. In some examples, the CU and/or DU/RU of the disaggregated base station (e.g., within the network entity 2100) may generate handover information and provide the information to a user equipment, as well as receive and process messages from the user equipment.

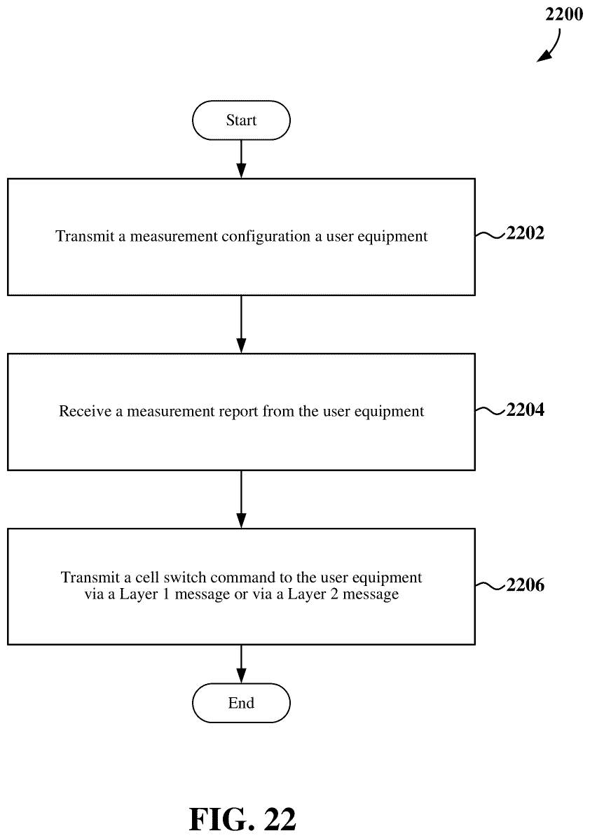

FIG. 22 is a flow chart illustrating an example method 2200 for wireless communication in accordance with some aspects of the present disclosure. As described below, some or all illustrated features may be omitted in a particular implementation within the scope of the present disclosure, and some illustrated features may not be required for implementation of all examples. In some examples, the method 2200 may be carried out by the network entity 2100 illustrated in FIG. 21. In some examples, the method 2200 may be carried out by any suitable apparatus or means for carrying out the functions or algorithm described below.

At block 2202, a network entity may transmit a measurement configuration to a user equipment. In some examples, the measurement processing circuitry 2142 together with the communication and processing circuitry 2141 and the transceiver 2110, shown and described in FIG. 21, may provide a means to transmit a measurement configuration to a user equipment.

At block 2204, the network entity may receive a measurement report from the user equipment. In some examples, the measurement processing circuitry 2142 together with the communication and processing circuitry 2141 and the transceiver 2110, shown and described in FIG. 21, may provide a means to receive a measurement report from the user equipment.

At block 2206, the network entity may transmit a cell switch command to the user equipment via a Layer 1 message or via a Layer 2 message. In some examples, the handover processing circuitry 2143 together with the communication and processing circuitry 2141 and the transceiver 2110, shown and described in FIG. 21, may provide a means to transmit a cell switch command to the user equipment via a Layer 1 message or via a Layer 2 message.

In some examples, the configuration specifies at least one first measurement metric for an inter-frequency Layer 1 measurement, and at least one second measurement metric for an intra-frequency Layer 1 measurement. In some examples, the at least one first measurement metric may include at least one of a Layer 1 reference signal received power (L1-RSRP), a Layer 1 reference signal received quality (L1-RSRQ), a Layer 1 signal-to-interference-and-noise ratio (L1-SINR), or channel quality information. In some examples, the at least one second measurement metric may include at least one of a Layer 1 reference signal received power (L1-RSRP), a Layer 1 signal-to-interference-and-noise ratio (L1-SINR), or channel quality information.

In some examples, the measurement report may include a measurement metric associated with a beam-level measurement. In some examples, the measurement report may include a measurement metric associated with a cell-level measurement.

In some examples, the configuration specifies at least one first resource for channel measurements, and at least one second resource for interference measurements. In some examples, conducting the Layer 1 measurement may include measuring signal on the at least one first resource and the at least one second resource, and generating the measurement report may include generating a Layer 1 signal-to-interference-and-noise ratio (L1-SINR) measurement metric based on the Layer 1 measurement. In some examples, the at least one first resource may include at least one channel measurement resource (CMR) set. In some examples, the at least one second resource may include at least one interference measurement resource (IMR) set.

In some examples, the CMR set may include at least one of a first periodic resource, a first semi-persistent resource, or a first aperiodic resource. In some examples, the IMR set may include at least one of a second periodic resource, a second semi-persistent resource, or a second aperiodic resource.

In some examples, the configuration specifies at least one of a single channel measurement resource (CMR) set for a single transmit receive point (TRP) measurement operation, or multiple CMR sets for a multiple TRP measurement operation. In some examples, conducting the Layer 1 measurement may include measuring signal on the single CMR set or the multiple CMR sets, and generating the measurement report may include generating a Layer 1 reference signal received power (L1-RSRP) measurement metric based on the Layer 1 measurement.

In some examples, the single CMR set may include at least one of a first periodic resource, a first semi-persistent resource, or a first aperiodic resource. In some examples, the multiple CMR sets may include at least one of second periodic resources, second semi-persistent resources, or second aperiodic resources.

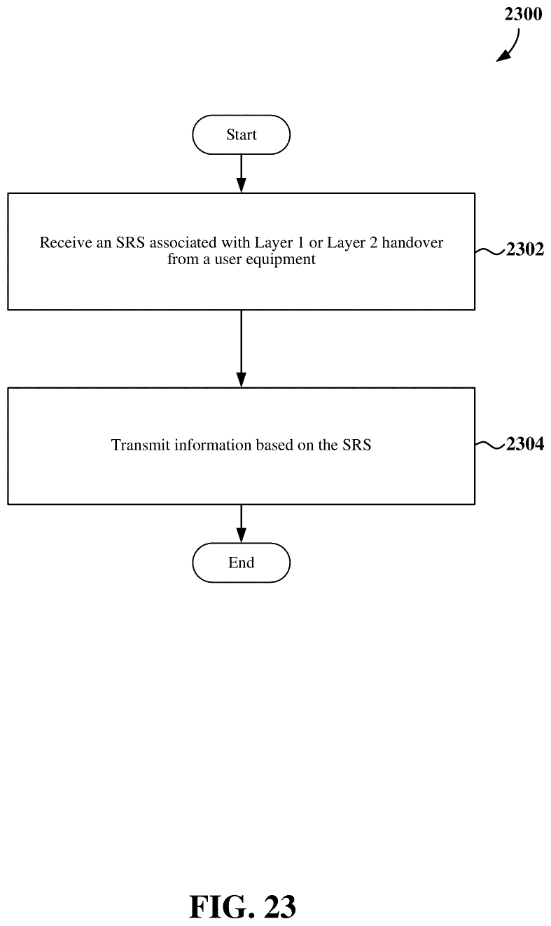

FIG. 23 is a flow chart illustrating an example method 2300 for wireless communication in accordance with some aspects of the present disclosure. As described below, some or all illustrated features may be omitted in a particular implementation within the scope of the present disclosure, and some illustrated features may not be required for implementation of all examples. In some examples, the method 2300 may be carried out by the network entity 2100 illustrated in FIG. 21. In some examples, the method 2300 may be carried out by any suitable apparatus or means for carrying out the functions or algorithm described below.

At block 2302, a network entity may receive an SRS associated with L1 or L2 handover from a UE. In some examples, the measurement processing circuitry 2142 together with the communication and processing circuitry 2141 and the transceiver 2110, shown and described in FIG. 21, may provide a means to receive an SRS associated with L1 or L2 handover from a UE.

At block 2304, the network entity may transmit information based on the SRS. In some examples, the measurement processing circuitry 2142 together with the communication and processing circuitry 2141 and the transceiver 2110, shown and described in FIG. 21, may provide a means to transmit information based on the SRS.

In some examples, the SRS may include (e.g., may be) an inter-frequency SRS transmission. In some examples, the SRS may include an intra-frequency SRS transmission.

In some examples, an SRS configuration specifies that the SRS is to be transmitted periodically, semi-persistently, or aperiodically.

In some examples, the SRS may include a Layer 1 inter-frequency SRS transmission, and the SRS configuration specifies at least one first SRS parameter associated with a serving cell of the user equipment and at least one second SRS parameter associated with the candidate cell. In some examples, the at least one first SRS parameter is different from the at least one second SRS parameter. In some examples, the at least one second SRS parameter may include at least one of a center frequency, a sub-carrier spacing (SCS), or a bandwidth part (BWP).

In some examples, an SRS configuration specifies at least one guard time between the SRS transmission and any other communication by the user equipment. In some examples, the at least one guard time specifies at least one of a first quantity of symbols before the SRS transmission, or a second quantity of symbols after the SRS transmission. In some examples, at least one of the first quantity of symbols or the second quantity of symbols is a fixed value. In some examples, at least one of the first quantity of symbols or the second quantity of symbols is based on a capability of the user equipment. In some examples, at least one of the first quantity of symbols or the second quantity of symbols is based on a first sub-carrier spacing (SCS) of a serving cell of the user equipment, or a second SCS of the candidate cell.

Referring again to FIG. 21, in one configuration, the network entity 2100 includes means for transmitting a measurement configuration to a user equipment, means for receiving a measurement report from the user equipment, and means for transmitting a cell switch command to the user equipment via a Layer 1 message or via a Layer 2 message. In one configuration, the network entity 2100 includes means for receiving a sounding reference signal (SRS) configuration associated with a Layer 1 mobility measurement, and means for transmitting an SRS transmission based on the SRS configuration to a candidate cell. In one aspect, the aforementioned means may be the processor 2104 shown in FIG. 21 configured to perform the functions recited by the aforementioned means (e.g., as discussed above). In another aspect, the aforementioned means may be a circuit or any apparatus configured to perform the functions recited by the aforementioned means.

Of course, in the above examples, the circuitry included in the processor 2104 is merely provided as an example, and other means for carrying out the described functions may be included within various aspects of the present disclosure, including but not limited to the instructions stored in the computer-readable medium 2106, or any other suitable apparatus or means described in any of FIGS. 1-4, 7-12, 14-16, 18, 21, 24, 29, and 30, and utilizing, for example, the methods and/or algorithms described herein in relation to FIGS. 22-23.

The methods shown in FIGS. 19, 20, 22, and 23 may include additional aspects, such as any single aspect or any combination of aspects described below and/or in connection with one or more other processes described elsewhere herein.

In some examples, a user equipment may include a transceiver, and a processor coupled to the transceiver. The processor may be configured to receive a sounding reference signal (SRS) configuration associated with a Layer 1 mobility measurement. The processor may also be configured to transmit an SRS transmission based on the SRS configuration to a candidate cell.

In some examples, a method for wireless communication at a user equipment is disclosed. The method may include receiving a sounding reference signal (SRS) configuration associated with a Layer 1 mobility measurement. The method may also include transmitting an SRS transmission based on the SRS configuration to a candidate cell.

In some examples, a user equipment may include means for receiving a sounding reference signal (SRS) configuration associated with a Layer 1 mobility measurement. The user equipment may also include means for transmitting an SRS transmission based on the SRS configuration to a candidate cell.

In some examples, a non-transitory computer-readable medium has stored therein instructions executable by one or more processors of a user equipment device to receive a sounding reference signal (SRS) configuration associated with a Layer 1 mobility measurement. The computer-readable medium may also have stored therein instructions executable by one or more processors of the user equipment to transmit an SRS transmission based on the SRS configuration to a candidate cell.

### Beam Reporting

The disclosure relates in some aspects to techniques for beam reporting. For example, a beam report may be transmitted in conjunction with a beam switch. In some examples, this beam reporting may be performed in conjunction with the candidate cell measurements discussed above.

To support switching of beams, a UE may be configured with beam reporting for a candidate cell, such as a candidate SpCell. Aspects provided herein provide different mechanisms for beam reporting, such as UE triggered or network triggered reporting. The different mechanisms for beam reporting may enable more efficient selection and reselection of beams for wireless communication, in turn improving the overall communication system. As used herein, the term “measurement result” or “measurement information” may refer to measurements for a beam of a candidate SpCell, such as RSRP, SINR, RSRQ, a block error rate (BLER), or other measurements for a beam. One candidate cell may be associated with N beams and N measurement results, where N may be a positive integer. A measurement result of the candidate SpCell may be indicated by a “Mn” information element (IE). A measurement result of the serving cell may be indicated by a “Mp” IE. An example measurement result may be expressed in decibel (dB) if it's RSRQ or SINR, or may be expressed in or decibel-milliwatts (dBm) if it's RSRP. As used herein, the term “beam report” may refer to a report transmitted from a UE to the network that may carry information based on the measurement results associated with one or more beams for one or more candidate cells to enable the network to perform various procedures related to a beam (e.g., beam selection, beam reselection, beam recovery, or the like). A beam report may be included in a CSI report, which may be a L1 inter-frequency CSI report or other type of CSI report. As used herein, the term “L1 inter-frequency CSI report” may refer to a report, such as a report in a PUSCH, that reports L1 (physical layer) inter-frequency measurement such as L1 RSRP, L1 RSRQ, L1 RSSI, or L1 SINR, to the network. As one example, an L1 inter-frequency report may include a subset of the measurement information. For example, measurement information based on the top N inter-frequency RSs across all the measured frequencies or across M UE-selected frequencies or the top N inter-frequency RSs per each measured frequency or each of the M UE-selected frequencies may be included in the L1 inter-frequency report. For another example, the measurement information may be cell specific, where the measurement result may be a linear average of Y best beams per candidate cell (Y being a positive integer greater than or equal to 1 which may be expressed as Y>=1). As used herein, the term “a configuration of inter-frequency RS reporting” may refer to a configuration indicative of RSs used for L1 inter-frequency RS reporting, such as one or more indexes. In some aspects, in a beam report, the UE may identify those beams with smallest pathloss or those beams with highest RSRP as “top beams.” A beam report may be periodic, aperiodic, or semi-persistent. A beam report transmitted from the UE to the network may be configured to be triggered by the UE, triggered by the network, or triggered by the UE and the network. As used herein, the term “trigger event” may refer to an event in which if it occurs (e.g., determined by the UE), the UE may transmit a beam report accordingly. A trigger event may include an “initial event” (which may also be referred to as an “entering event”) where the UE may start transmission of one or more beam reports based on the initial event occurring (e.g., determined by the UE). A trigger event may include an “exit event” where the UE may stop transmission of one or more beam reports based on the exit event occurring (e.g., determined by the UE). A trigger event may be associated with a threshold parameter (e.g., used for determining whether the event occurred) indicated by “Thresh.” As used herein, the term “hysteresis parameter” may be a parameter expressed in decibels (dBs) and may be indicated by a “hys” IE. A “measurement object offset” may be an offset expressed in dBs of a reference signal (e.g., associated with a beam) of the candidate SpCell or the serving cell. A measurement object offset of a reference signal of the candidate SpCell may be indicated by a “Ofn” IE. A reference signal may be associated with one beam associated with the candidate SpCell. A measurement object offset of a reference signal of the serving cell may be indicated by a “Ofp” IE. A “cell specific offset” may be an offset expressed in dBs of the candidate SpCell or the serving cell. A cell specific offset of the candidate SpCell may be indicated by a “Ocn” IE. A cell specific offset of the serving cell may be indicated by a “Ocp” IE. An offset in dBs associated with a trigger event may be indicated by a “Off” IE.

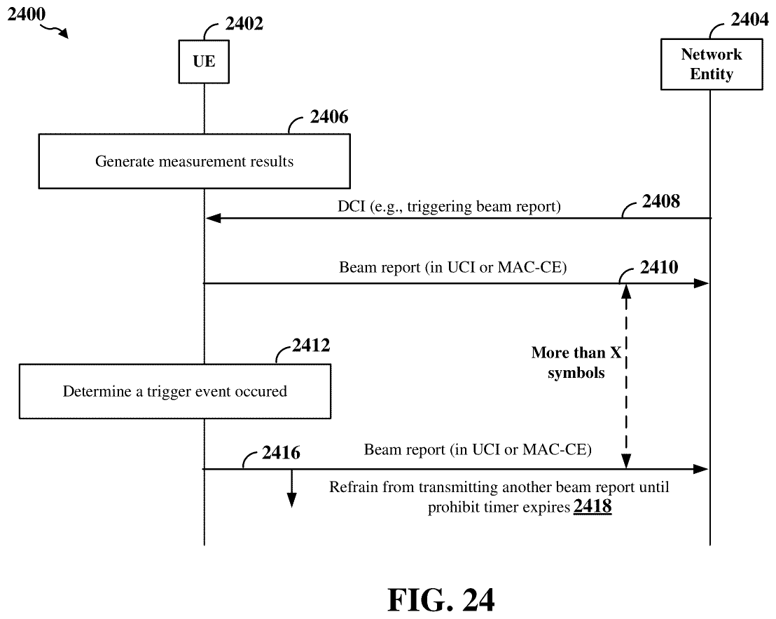

FIG. 24 is a diagram 2400 illustrating example communications between a network entity 2404 and a UE 2402. In some aspects, the network entity 2404 may be a network node. In some aspects, the network node may be implemented as an aggregated base station, a disaggregated base station, an integrated access and backhaul (IAB) node, a relay node, a sidelink node, or the like. In some aspects, the network entity 2404 may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC. In some examples, the network entity 2404 may correspond to any of the network entities, base stations, CUs, DUs, RUs, or scheduling entities shown in any of FIGS. 1-4, 7-12, 14-16, 21, 29, and 30. In some examples, the UE 2402 may correspond to any of the UEs or scheduled entities shown in any of FIGS. 1-4, 7-12, 14-16, 18, 29, and 30.

In some aspects, beam reporting may be initiated by the network entity 2404. As illustrated in FIG. 24, the network entity 2404 may transmit a DCI 2408 that may trigger the transmission of at least one beam report, such as an aperiodic CSI report, for a candidate cell to the UE 2402. In some aspects, measurements (e.g., L1 measurements) for the candidate cell may be periodic, aperiodic, or semi-persistent. For example, the UE 2402 may generate a set of measurement results associated with one or more beams at block 2406. In some aspects, the one or more beams are associated with one or more candidate SpCells for L1 or L2 mobility. For example, a first subset of the one or more beams may be associated with (e.g., belong to) a first candidate SpCell of the one or more candidate SpCells and a second subset of the one or more beams may be associated with a second candidate SpCell of the one or more candidate SpCells.

In some aspects, based on receiving the DCI 2408 that may trigger beam reporting, the UE 2402 may transmit a beam report 2410 (e.g., based on the measurement results generated at block 2406) to the network entity 2404. In some aspects, the beam report 2410 may be transmitted in an active serving cell or a candidate cell. In some aspects, the beam report 2410 may be a CSI report. In some aspects, the beam report 2410 may be included in UCI, which may be transmitted in a PUCCH, a dynamic grant (DG) PUSCH, or a configured grant (CG) PUSCH. In some aspects, the beam report 2410 may be included in a single-part UCI including information indicative of N beams (e.g., the beam identifiers respectively associated with the N beams) and N beam metrics (e.g., N measurement results such as SINR, RSRP, RSRQ, BLER or other metrics respectively associated with the N beams) for a candidate cell. In some aspects, the beam report 2410 may be included in a two-part UCI including a first part and a second part. The first part may include candidate cell identifiers (IDs) or physical cell identifiers (PCIs) and the quantity of beams respectively associated with each candidate cell ID or PCI. The second part may include corresponding beam identifiers and the beam metrics (e.g., respectively associated measurement results associated with the beam identifiers) for each candidate cell (e.g., identified by the candidate cell ID or the PCI). In some aspects, the beam report 2410 may cause the UCI to exceed a payload of a PUCCH or a PUSCH. In some of such aspects, the UE 2402 may perform UCI omission based on the priority or priorities of different UCIs included in the PUCCH or PUSCH. In some aspects, a UCI including the beam report 2410 for a candidate cell may have the same priority as a second UCI including a beam report for a serving cell (which may be referred to as an “active serving cell”). In some aspects, a UCI including the beam report 2410 for a candidate cell may have a lower priority than a second UCI including a beam report for a serving cell (which may be referred to as an “active serving cell”). In some aspects, the beam report 2410 may be included in a MAC-CE, which may be transmitted in a PUSCH. In some aspects, the MAC-CE may include one or more candidate cell IDs or PCIs. In some aspects, the MAC-CE may also include N beams (e.g., the beam identifiers respectively associated with the N beams) and N beam metrics (e.g., N measurement results such as SINR, RSRP, RSRQ, BLER or other metrics respectively associated with the N beams) for each candidate cell ID or PCI of the one or more candidate cell IDs or PCIs.

In some aspects, beam reporting may be initiated by the UE 2402. As illustrated in FIG. 24, the UE 2402 may determine that a trigger event has occurred at block 2412. In some aspects, a beam metric, such as L1-RSRP, L1-SINR, RSSI, channel quality indicator (CQI), or a BLER, may be defined. A trigger event may be defined based on the beam metric. For example, the UE 2402 may be configured to trigger beam reporting when the beam metric is changed. In some aspects, the trigger event may be that a cell average RSRP for a candidate cell is above a threshold. For example, if the L1 measurement result Ms (e.g., cell average RSRP) for the candidate cell is above the threshold, the UE 2402 may determine that the trigger event has occurred at block 2412. In some of such aspects, the entering event may be Ms>Thresh+Hys (measurement result of candidate cell is larger than threshold plus a hysteresis parameter) and the leaving event may be Ms<Thresh−Hys (measurement result of candidate cell is smaller than threshold minus the hysteresis parameter).

In some aspects, the trigger event may be that a cell average RSRP of a candidate cell is larger than a cell average RSRP of an active serving cell by a threshold. For example, if the L1 measurement result Mn of the candidate cell (e.g., the cell average RSRP) is larger than the L1 measurement result Mp of the active serving cell by the threshold, the UE 2402 may determine that the trigger event has occurred at block 2412. For example, an entering event may be Mn+Ofn+Ocn−Hys>Mp+Ofp+Ocp+Off (e.g., measurement result of candidate cell plus measurement object offset associated with the candidate cell plus cell specific offset associated with the candidate cell minus the hysteresis parameter is greater than measurement result of serving cell plus measurement object offset associated with the serving cell plus cell specific offset associated with the serving cell plus an offset) and an leaving event may be Mn+Ofn+Ocn+Hys<Mp+Ofp+Ocp+Off (e.g., measurement result of candidate cell plus measurement object offset associated with the candidate cell plus cell specific offset associated with the candidate cell plus the hysteresis parameter is smaller than measurement result of serving cell plus measurement object offset associated with the serving cell plus cell specific offset associated with the serving cell plus the offset).

In some aspects, based on determining the trigger event at block 2412, the UE 2402 may transmit a beam report 2416 (e.g., based on the measurement results generated at block 2406) to the network entity 2404. In some aspects, the beam report 2416 may be transmitted in an active serving cell or a candidate cell. In some aspects, the beam report 2416 may be a CSI report. In some aspects, the beam report 2416 may be included in UCI, which may be transmitted in a PUCCH, a dynamic grant PUSCH, or a configured grant PUSCH. In some aspects, the beam report 2416 may be included in a single-part UCI including information indicative of N beams (e.g., the beam identifiers respectively associated with the N beams) and N beam metrics (e.g., N measurement results such as SINR, RSRP, RSRQ, BLER or other metrics respectively associated with the N beams) for a candidate cell or for multiple candidate cells. In some aspects, the beam report 2416 may be included in a two-part UCI including a first part and a second part. The first part may include candidate cell identifiers (IDs) or physical cell identifiers (PCIs) and the quantity of beams respectively associated with each candidate cell ID or PCI. The second part may include corresponding beam identifiers and the beam metrics (e.g., respectively associated measurement results associated with the beam identifiers) for each candidate cell (e.g., identified by the candidate cell ID or the PCI). In some aspects, the beam report 2416 may cause the UCI to exceed a payload of a PUCCH or a PUSCH. In some of such aspects, the UE 2402 may perform UCI omission based on the priority or priorities of different UCIs included in the PUCCH or PUSCH. In some aspects, a UCI including the beam report 2416 for a candidate cell may have the same priority as a second UCI including a beam report for a serving cell (which may be referred to as an “active serving cell”). In some aspects, a UCI including the beam report 2416 for a candidate cell may have a lower priority than a second UCI including a beam report for a serving cell (which may be referred to as an “active serving cell”). In some aspects, the beam report 2416 may be included in a MAC-CE, which may be transmitted in a PUSCH. In some aspects, the MAC-CE may include one or more candidate cell IDs or PCIs. In some aspects, the MAC-CE may also include N beams (e.g., the beam identifiers respectively associated with the N beams) and N beam metrics (e.g., N measurement results such as SINR, RSRP, RSRQ, BLER or other metrics respectively associated with the N beams) for each candidate cell ID or PCI of the one or more candidate cell IDs or PCIs.

In some aspects, the UE 2402 may be configured with a prohibit timer. For example, the UE 2402 may start the prohibit timer when the beam report 2416 is transmitted. The prohibit timer may expire after a configured duration. When the prohibit timer is running (e.g., until the prohibit timer expires), the UE 2402 may refrain from transmitting another beam report (as represented by the arrow 2418).

In some aspects, the UE 2402 may be configured with a dedicated scheduling request for beam report for a candidate cell. For example, to transmit the beam report 2410, the UE 2402 may transmit a dedicated scheduling request for beam report to the network entity 2404.

In some aspects, both UE initiated (e.g., based on trigger event) and network entity initiated periodic, semi-persistence, or aperiodic reporting may be configured for a candidate cell. In some of such aspects, the UE 2402 may refrain from transmitting a trigger report in a duration before (e.g., such as a number of X symbols before, X being a configured positive integer) or a duration after (e.g., such as a number of X symbols after) a network entity initiated beam report.

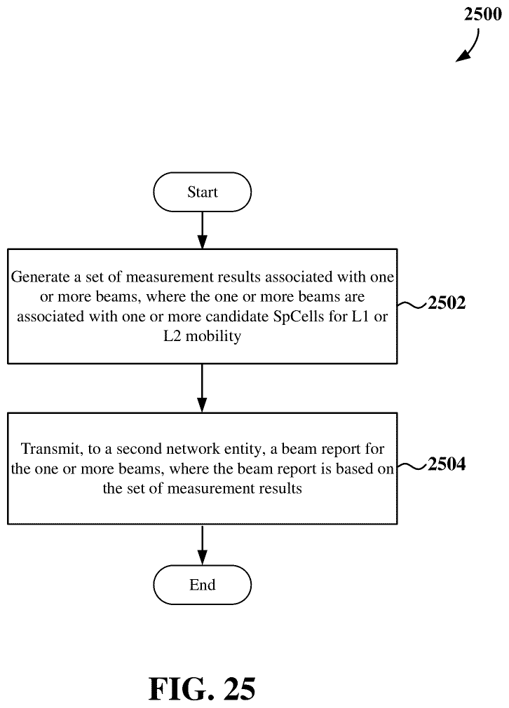

FIG. 25 is a flowchart 2500 of a method of wireless communication. The method may be performed by a first network entity (e.g., the UE 304, the UE 2402, the apparatus 2904, or any other UE or scheduled entity described herein).

At block 2502, the first network entity may generate a set of measurement results associated with one or more beams, where the one or more beams are associated with one or more candidate SpCells for L1 or L2 mobility. For example, the UE 2402 of FIG. 24 may generate a set of measurement results associated with one or more beams at block 2406, where the one or more beams are associated with one or more candidate SpCells for L1 or L2 mobility. In some aspects, block 2502 may be performed by the report component 398.

At block 2504, the first network entity may transmit, to a second network entity, a beam report for the one or more beams, where the beam report is based on the set of measurement results. For example, the UE 2402 of FIG. 24 may transmit, to a second network entity 2404, a beam report (e.g., the beam report 2410 or the beam report 2416) for the one or more beams, where the beam report is based on the set of measurement results. In some aspects, block 2504 may be performed by the report component 398.

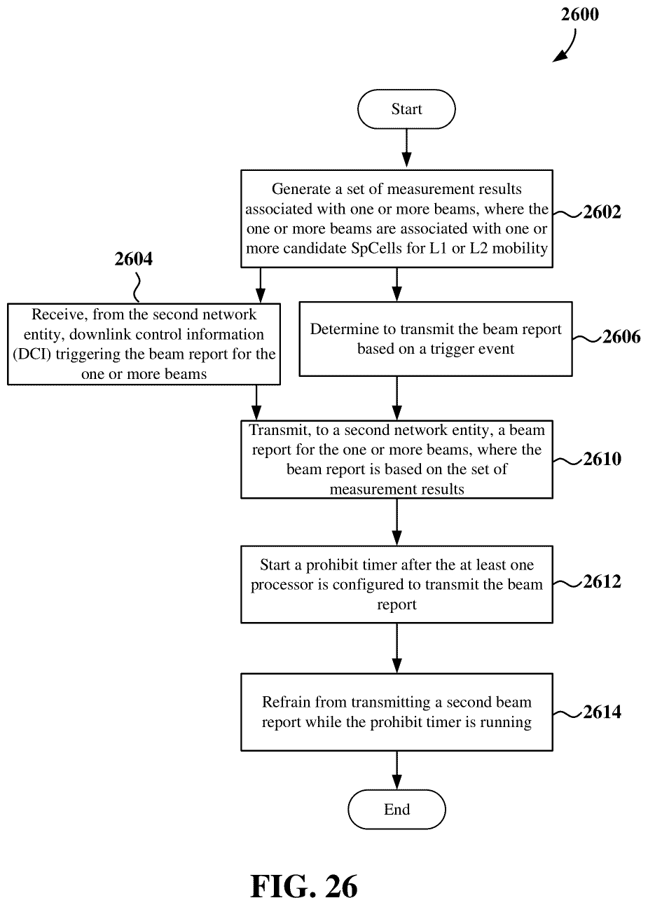

FIG. 26 is a flowchart 2600 of a method of wireless communication. The method may be performed by a first network entity (e.g., the UE 304, the UE 2402, the apparatus 2904, or any other UE or scheduled entity described herein).

At block 2602, the first network entity may generate a set of measurement results associated with one or more beams, where the one or more beams are associated with one or more candidate SpCells for L1 or L2 mobility. For example, the UE 2402 of FIG. 24 may generate a set of measurement results associated with one or more beams at 2406, where the one or more beams are associated with one or more candidate SpCells for L1 or L2 mobility. In some aspects, block 2602 may be performed by the report component 398.

At block 2604, the first network entity may receive, from the second network entity, DCI triggering the beam report for the one or more beams. For example, the UE 2402 of FIG. 24 may receive, from the second network entity 2404, DCI (e.g., DCI 2408) triggering the beam report for the one or more beams. In some aspects, block 2604 may be performed by the report component 398. In some aspects, the beam report is aperiodic. In some aspects, the beam report is periodic or semi-persistent.

At block 2606, the first network entity may determine to transmit the beam report based on a trigger event based on a measurement result of the set of measurement results associated with one candidate SpCell of the one or more candidate SpCells. For example, the UE 2402 of FIG. 24 may determine to transmit the beam report (e.g., at block 2412 of FIG. 24) based on a trigger event based on a measurement result of the set of measurement results associated with one candidate SpCell of the one or more candidate SpCells. In some aspects, block 2606 may be performed by the report component 398. In some aspects, the measurement result is one of an L1 RSRP, an L1 RSRQ, an L1 SINR, or a BLER. In some aspects, the trigger event is based on the measurement result being higher than a measurement threshold. In some aspects, the trigger event includes an initial event and an exit event, where the initial event is based on the measurement result being higher than a measurement threshold plus a hysteresis parameter, and where the exit event is based on the measurement result being lower than the measurement threshold minus the hysteresis parameter. In some aspects, the trigger event is based on the measurement result being higher than a second measurement result associated with a serving cell plus a measurement threshold. In some aspects, the trigger event includes an initial event and an exit event, where the initial event is based on Mn+Ofn+Ocn−Hys>Mp+Ofp+Ocp+Off, where the exit event is based on Mn+Ofn+Ocn+Hys<Mp+Ofp+Ocp+Off, where Mn is indicative of the measurement result, Ofn is indicative of a measurement object offset associated with the candidate SpCell, Ocn is indicative of a cell specific offset associated with the candidate SpCell, Ofp is indicative of a measurement object offset associated with a serving cell, Ocp is indicative of a cell specific offset associated with the serving cell, Mp is indicative of the second measurement result, Off is indicative of an offset parameter associated with the trigger event, and Hys is indicative of a hysteresis parameter.

At block 2610, the first network entity may transmit, to a second network entity, a beam report for the one or more beams, where the beam report is based on the set of measurement results. For example, the UE 2402 of FIG. 24 may transmit, to a second network entity 2404, a beam report (e.g., beam report 2410 or beam report 2416) for the one or more beams, where the beam report is based on the set of measurement results. In some aspects, block 2610 may be performed by the report component 398. In some aspects, to transmit the beam report, the UE may transmit, to the second network entity, a scheduling request for the beam report. In some aspects, the beam report is included in UCI, where the UCI is included in a PUCCH transmission, a dynamic grant PUSCH transmission, or a CG PUSCH transmission. In some aspects, the UCI is a single part UCI including information indicative of the one or more beams and information indicative of the set of measurement results. In some aspects, the UCI includes a first part and a second part, where the first part is indicative of a cell identifier and a subset of beams of the one or more beams associated with each candidate SpCell of the one or more candidate SpCells, and where the second part is indicative of at least one beam identifier associated with the subset of beams and a subset of measurement results of the set of measurement results associated with each candidate SpCell of the one or more candidate SpCells. In some aspects, the UCI is associated with a priority equal to a second priority of a second UCI including a second beam report associated with an active serving cell. In some aspects, the UCI is associated with a priority lower than a second priority associated with a second UCI including a second beam report associated with an active serving cell. In some aspects, the beam report is included in MAC-CE indicative of one or more candidate cell identifiers respectively associated with the one or more candidate SpCells. In some aspects, the MAC-CE is indicative of a subset of beams of the one or more beams and a subset of measurement results of the set of measurement results for each candidate SpCell of the one or more candidate SpCells.

At block 2612, the first network entity may start a prohibit timer after the at least one processor is configured to transmit the beam report. For example, the UE 2402 of FIG. 24 may start a prohibit timer after the at least one processor is configured to transmit the beam report. In some aspects, block 2612 may be performed by the report component 398.

At block 2614, the first network entity may refrain from transmitting a second beam report while the prohibit timer is running. For example, the UE 2402 of FIG. 24 may refrain from transmitting a second beam report while the prohibit timer is running. In some aspects, block 2614 may be performed by the report component 398.

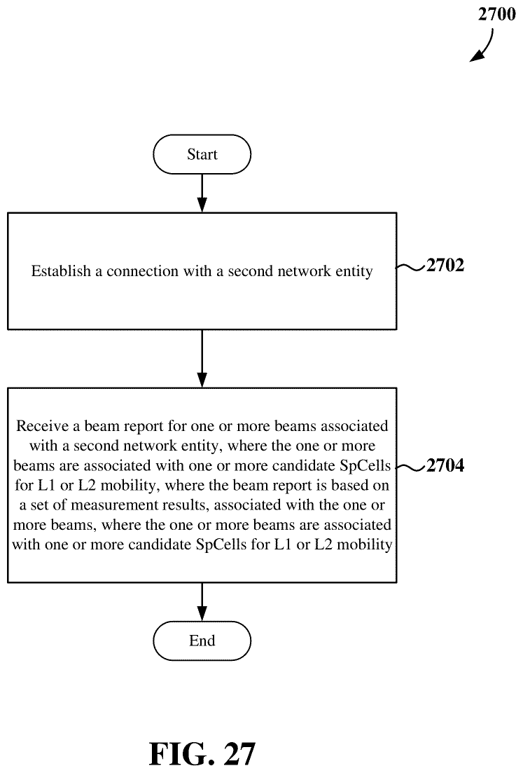

FIG. 27 is a flowchart 2700 of a method of wireless communication. The method may be performed by a network entity (e.g., the base station 302, the network entity 2404 the network entity 2902, the network entity 3002, or any other network entity described herein).

At block 2702, the network entity may establish a connection with a second network entity. For example, the network entity 2404 of FIG. 24 may establish a connection with a second network entity (e.g., the UE 2402). In some aspects, block 2702 may be performed by the report component 399.

At block 2704, the network entity may receive a beam report for one or more beams associated with a second network entity, where the one or more beams are associated with one or more candidate SpCells for L1 or L2 mobility, where the beam report is based on a set of measurement results, associated with the one or more beams, where the one or more beams are associated with one or more candidate SpCells for L1 or L2 mobility. For example, the network entity 2404 of FIG. 24 may receive a beam report (e.g., the beam report 2410 or the beam report 2416) for one or more beams associated with a second network entity (e.g., the UE 2402), where the one or more beams are associated with one or more candidate SpCells for L1 or L2 mobility, where the beam report is based on a set of measurement results, associated with the one or more beams, where the one or more beams are associated with one or more candidate SpCells for L1 or L2 mobility. In some aspects, block 2704 may be performed by the report component 399.

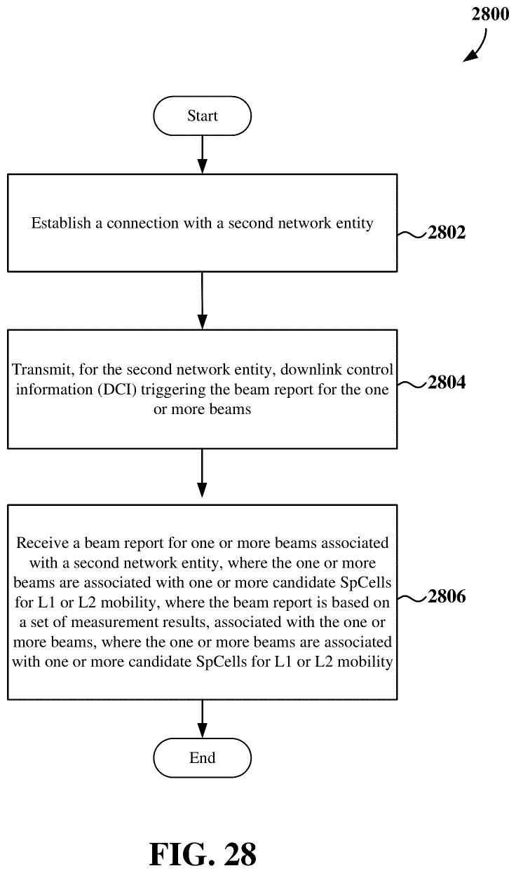

FIG. 28 is a flowchart 2800 of a method of wireless communication. The method may be performed by a network entity (e.g., the base station 302, the network entity 2404 the network entity 2902, the network entity 3002, or any other network entity described herein).

At block 2802, the network entity may establish a connection with a second network entity. For example, the network entity 2404 of FIG. 24 may establish a connection with a second network entity (e.g., the UE 2402). In some aspects, block 2802 may be performed by the report component 399.

At 2803, the network entity may transmit, for the second network entity, DCI triggering the beam report for the one or more beams. For example, the network entity 2404 of FIG. 24 may transmit, for the second network entity (e.g., the UE 2402), DCI (e.g., DCI 2408) triggering the beam report for the one or more beams. In some aspects, block 2803 may be performed by the report component 399.

At block 2804, the network entity may receive a beam report for one or more beams associated with a second network entity, where the one or more beams are associated with one or more candidate SpCells for L1 or L2 mobility, where the beam report is based on a set of measurement results, associated with the one or more beams, where the one or more beams are associated with one or more candidate SpCells for L1 or L2 mobility. For example, the network entity 2404 of FIG. 24 may receive a beam report (e.g., the beam report 2410 or the beam report 2416) for one or more beams associated with a second network entity (e.g., the UE 2402), where the one or more beams are associated with one or more candidate SpCells for L1 or L2 mobility, where the beam report is based on a set of measurement results, associated with the one or more beams, where the one or more beams are associated with one or more candidate SpCells for L1 or L2 mobility. In some aspects, block 2804 may be performed by the report component 399. In some aspects, the beam report is included in UCI, where the UCI is included in a PUCCH transmission, a dynamic grant PUSCH transmission, or a CG PUSCH transmission. In some aspects, the UCI is a single part UCI including information indicative of the one or more beams and information indicative of the set of measurement results. In some aspects, the UCI includes a first part and a second part, where the first part is indicative of a cell identifier and a subset of beams of the one or more beams associated with each candidate SpCell of the one or more candidate SpCells, and where the second part is indicative of at least one beam identifier associated with the subset of beams and a subset of measurement results of the set of measurement results associated with each candidate SpCell of the one or more candidate SpCells. In some aspects, the UCI is associated with a priority equal to a second priority of a second UCI including a second beam report associated with an active serving cell. In some aspects, the UCI is associated with a priority lower than a second priority associated with a second UCI including a second beam report associated with an active serving cell. In some aspects, the beam report is included in MAC-CE indicative of one or more candidate cell identifiers respectively associated with the one or more candidate SpCells. In some aspects, the MAC-CE is indicative of a subset of beams of the one or more beams and a subset of measurement results of the set of measurement results for each candidate SpCell of the one or more candidate SpCells.

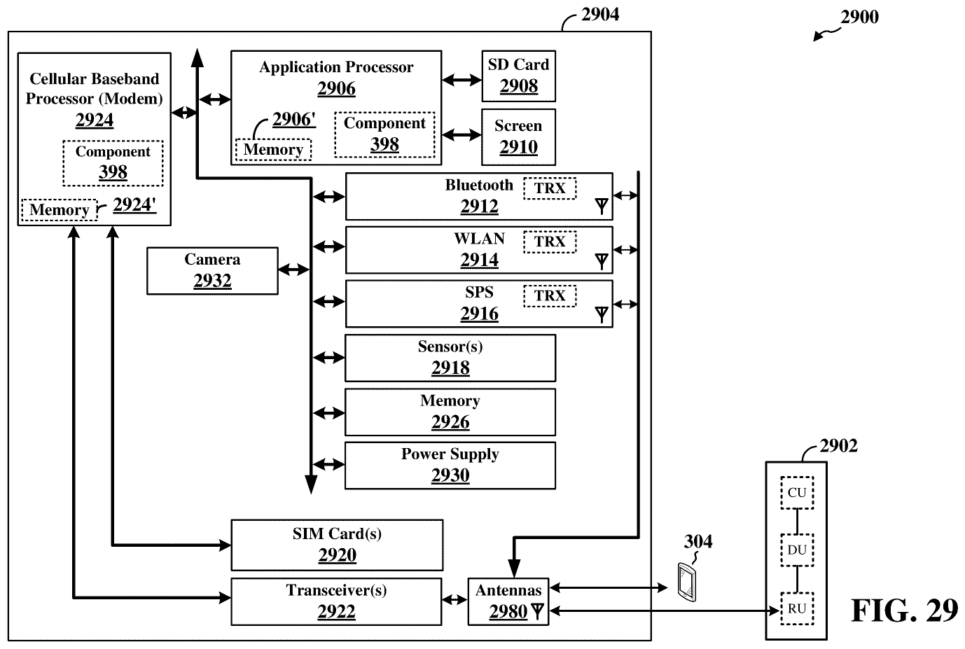

FIG. 29 is a diagram 2900 illustrating an example of a hardware implementation for an apparatus 2904. The apparatus 2904 may be a UE, a component of a UE, or may implement UE functionality. In some examples, the apparatus 2904 may correspond to any of the UEs or scheduled entities shown in any of FIGS. 1-4, 8-12, 14-16, 18, 24, 29, and 30. In some aspects, the apparatus 2904 may include one or more cellular baseband processors (e.g., cellular baseband processor 2924), also referred to as a modem, coupled to one or more transceivers 2922 (e.g., cellular RF transceiver). The cellular baseband processor 2924 may include one or more on-chip memories (e.g., on-chip memory 2924′). In some aspects, the apparatus 2904 may further include one or more subscriber identity modules (SIM) cards 2920 and one or more application processors (e.g., application processor 2906) coupled to a secure digital (SD) card 2908 and a screen 2910. The application processor 2906 may include one or more on-chip memories (e.g., on-chip memory 2906′). In some aspects, the apparatus 2904 may further include a Bluetooth module 2912, a WLAN module 2914, a satellite system module 2916 (e.g., GNSS module), one or more sensor modules 2918 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), one or more additional memory modules 2926, a power supply 2930, and/or a camera 2932. The Bluetooth module 2912, the WLAN module 2914, and the satellite system module 2916 may include an on-chip transceiver (TRX)/receiver (RX). The cellular baseband processor 2924 communicates through the transceiver(s) 2922 via one or more antennas 2980 with the UE 294 and/or with an RU associated with a network entity 2902. The cellular baseband processor 2924 and the application processor 2906 may each include a computer-readable medium/memory 2924′, 2906′, respectively. The additional memory modules 2926 may also be considered a computer-readable medium/memory. Each computer-readable medium/memory 2924′, 2906′, 2926 may be non-transitory. The cellular baseband processor 2924 and the application processor 2906 are each responsible for general processing, including the execution of software stored on the computer-readable medium/memory. The software, when executed by the cellular baseband processor 2924/application processor 2906, causes the cellular baseband processor 2924/application processor 2906 to perform the various functions described herein. The computer-readable medium/memory may also be used for storing data that is manipulated by the cellular baseband processor 2924/application processor 2906 when executing software. The cellular baseband processor 2924/application processor 2906 may be a component of the UE 450 and may include the memory 460 and/or at least one of the TX processor 468, the RX processor 456, and the controller/processor 459. In one configuration, the apparatus 2904 may be a processor chip (modem and/or application) and include just the cellular baseband processor 2924 and/or the application processor 2906, and in another configuration, the apparatus 2904 may be the entire UE (e.g., see the UE 450 of FIG. 4) and include the additional modules of the apparatus 2904.

As discussed herein, the report component 398 may be configured to generate a set of measurement results associated with one or more beams, where the one or more beams are associated with one or more candidate SpCells for L1 or L2 mobility. In some aspects, the report component 398 may be further configured to transmit, to a second network entity, a beam report for the one or more beams, where the beam report is based on the set of measurement results. The report component 398 may be within the cellular baseband processor 2924, the application processor 2906, or both the cellular baseband processor 2924 and the application processor 2906. The report component 398 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 2904 may include a variety of components configured for various functions. In one configuration, the apparatus 2904, and in particular the cellular baseband processor 2924 and/or the application processor 2906, includes means for generating a set of measurement results associated with one or more beams, where the one or more beams are associated with one or more candidate SpCells for L1 or L2 mobility. In some aspects, the apparatus 2904 may further include means for receiving, from the second network entity, DCI triggering the beam report for the one or more beams. In some aspects, the apparatus 2904 may further include means for determining to transmit the beam report based on a trigger event based on a measurement result of the set of measurement results associated with one candidate SpCell of the one or more candidate SpCells. In some aspects, the apparatus 2904 may further include means for transmitting, to a second network entity, a beam report for the one or more beams, where the beam report is based on the set of measurement results. In some aspects, the apparatus 2904 may further include means for starting a prohibit timer after the at least one processor is configured to transmit the beam report. In some aspects, the apparatus 2904 may further include means for refraining from transmitting a second beam report while the prohibit timer is running. In some aspects, the apparatus 2904 may further include means for transmitting, to the second network entity, a scheduling request for the beam report. The means may be the report component 398 of the apparatus 2904 configured to perform the functions recited by the means. As described herein, the apparatus 2904 may include the TX processor 468, the RX processor 456, and the controller/processor 459. As such, in one configuration, the means may be the TX processor 468, the RX processor 456, and/or the controller/processor 459 configured to perform the functions recited by the means.

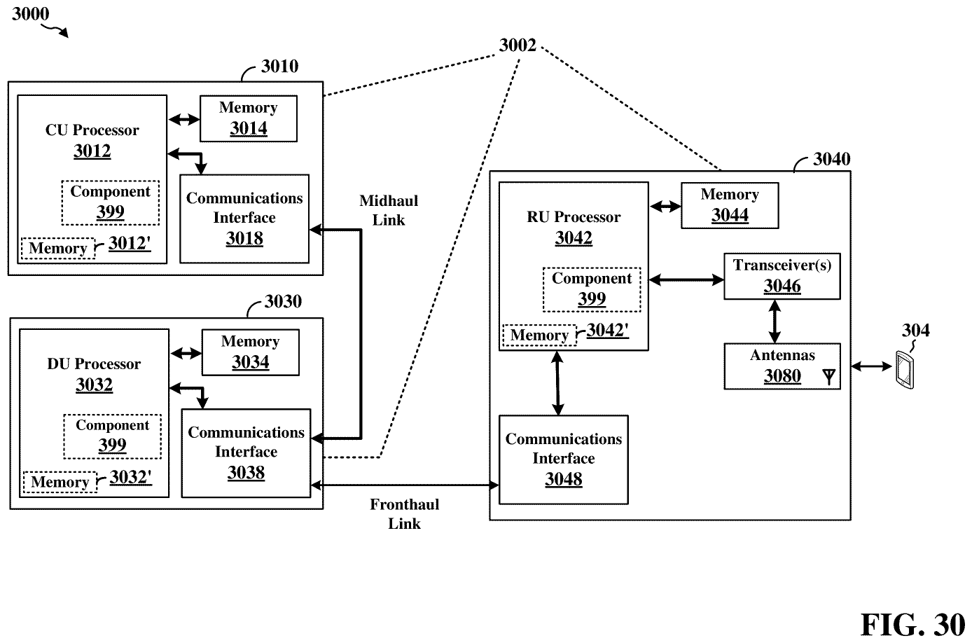

FIG. 30 is a diagram 3000 illustrating an example of a hardware implementation for a network entity 3002. The network entity 3002 may be a BS, a component of a BS, or may implement BS functionality. In some examples, the network entity 3002 may correspond to any of the network entities, base stations, CUs, DUs, RUs, or scheduling entities shown in any of FIGS. 1-4, 8-12, 14-16, 21, 24, and 29. The network entity 3002 may include at least one of a CU 3010, a DU 3030, or an RU 3040. For example, depending on the layer functionality handled by the component 399, the network entity 3002 may include the CU 3010; both the CU 3010 and the DU 3030; each of the CU 3010, the DU 3030, and the RU 3040; the DU 3030; both the DU 3030 and the RU 3040; or the RU 3040. The CU 3010 may include one or more CU processors (e.g., a CU processor 3012). The CU processor 3012 may include one or more on-chip memories (e.g., on-chip memory 3012′ and on-chip memory 3014′). In some aspects, the CU 3010 may further include one or more additional memory modules (e.g., additional memory modules 3014) and a communications interface 3018. The CU 3010 communicates with the DU 3030 through a midhaul link, such as an F1 interface. The DU 3030 may include one or more DU processors (e.g., a DU processor 3032). The DU processor 3032 may include one or more on-chip memories (e.g., on-chip memory 3032′). In some aspects, the DU 3030 may further include one or more additional memory modules (e.g., additional memory modules 3034) and a communications interface 3038. The DU 3030 communicates with the RU 3040 through a fronthaul link. The RU 3040 may include one or more RU processors (e.g., an RU processor 3042). The RU processor 3042 may include one or more on-chip memories (e.g., on-chip memory 3042′). In some aspects, the RU 3040 may further include one or more additional memory modules (e.g., additional memory modules 3044), one or more transceivers 3046, antennas 3080, and a communications interface 3048. The RU 3040 communicates with the UE 294. The on-chip memory 3012′, 3032′, 3042′ and the additional memory modules 3014, 3034, 3044 may each be considered a computer-readable medium/memory. Each computer-readable medium/memory may be non-transitory. Each of the processors 3012, 3032, 3042 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the report component 399 may be configured to establish a connection with a second network entity. In some aspects, the report component 399 may be further configured to receive a beam report for one or more beams associated with a second network entity, where the one or more beams are associated with one or more candidate SpCells for L1 or L2 mobility, where the beam report is based on a set of measurement results, associated with the one or more beams, where the one or more beams are associated with one or more candidate SpCells for L1 or L2 mobility. The report component 399 may be within one or more processors of one or more of the CU 3010, DU 3030, and the RU 3040. The report component 399 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 3002 may include a variety of components configured for various functions. In one configuration, the network entity 3002 includes means for establishing a connection with a second network entity. In some aspects, the network entity 3002 may further include means for transmitting, for the second network entity, DCI triggering the beam report for the one or more beams. In some aspects, the network entity 3002 may further include means for receiving, from a second network entity, a beam report for one or more beams, where the one or more beams are associated with one or more candidate SpCells for L1 or L2 mobility, where the beam report is based on a set of measurement results, associated with the one or more beams, where the one or more beams are associated with one or more candidate SpCells for L1 or L2 mobility. The means may be the report component 399 of the network entity 3002 configured to perform the functions recited by the means. As described herein, the network entity 3002 may include the TX processor 416, the RX processor 470, and the controller/processor 475. As such, in one configuration, the means may be the TX processor 416, the RX processor 470, and/or the controller/processor 475 configured to perform the functions recited by the means.

In an aspect of the disclosure, a method, a computer-readable medium, and an apparatus at a first network entity, such as a user equipment (UE) are provided. The apparatus may include a memory and at least one processor coupled to the memory. The at least one processor may be configured to generate a set of measurement results associated with one or more beams, where the one or more beams are associated with one or more candidate special cells (SpCells) for Layer 1 (L1) or Layer 2 (L2) mobility. The at least one processor may be configured to transmit, to a second network entity, a beam report for the one or more beams, where the beam report is based on the set of measurement results.

In another aspect of the disclosure, a method, a computer-readable medium, and an apparatus at a first network entity, such as a network node (e.g., a base station) are provided. The apparatus may include a memory and at least one processor coupled to the memory. The at least one processor may be configured to establish a connection with a second network entity. The at least one processor may be configured to receive a beam report for one or more beams associated with a second network entity, where the one or more beams are associated with one or more candidate SpCells for L1 or L2 mobility, where the beam report is based on a set of measurement results, associated with the one or more beams, where the one or more beams are associated with one or more candidate SpCells for L1 or L2 mobility.

The following provides an overview of several aspects of the present disclosure.
Aspect 1: A method for wireless communication at a user equipment, the method comprising: conducting a Layer 1 measurement based on a reference signal received from a first cell; generating a measurement report based on the Layer 1 measurement; and transmitting the measurement report to a second cell via a Layer 1 message.
Aspect 2: The method of aspect 1, wherein the Layer 1 message comprises uplink control information (UCI).
Aspect 3: The method of aspect 1 or 2, wherein the reference signal comprises a channel state information-reference signal (CSI-RS) or a synchronization signal block (SSB) signal.
Aspect 4: The method of any of aspects 1 through 3, further comprising receiving a configuration that specifies at least one of: at least one first measurement metric for an inter-frequency Layer 1 measurement; and at least one second measurement metric for an intra-frequency Layer 1 measurement.
Aspect 5: The method of aspect 4, wherein the configuration is based on at least one capability of the user equipment.
Aspect 6: The method of any of aspects 4 through 5, wherein the at least one first measurement metric comprises at least one of: a Layer 1 reference signal received power (L1-RSRP), a Layer 1 reference signal received quality (L1-RSRQ), or a Layer 1 signal-to-interference-and-noise ratio (L1-SINR).
Aspect 7: The method of any of aspects 4 through 6, wherein the at least one second measurement metric comprises at least one of: a Layer 1 reference signal received power (L1-RSRP), or a Layer 1 signal-to-interference-and-noise ratio (L1-SINR).
Aspect 8: The method of any of aspects 1 through 7, wherein: the measurement report comprises a measurement metric associated with a beam-level measurement; or the measurement report comprises a measurement metric associated with a cell-level measurement.
Aspect 9: The method of any of aspects 1 through 8, further comprising: receiving, from the second cell, a cell switch command via a first Layer 1 message or via a first Layer 2 message, the cell switch command identifying the first cell for handover of the user equipment; and transmitting a handover complete message to the first cell in response to the cell switch command, the handover complete message being transmitted via a second Layer 1 message or via a second Layer 2 message.
Aspect 10: The method of any of aspects 1 through 9, further comprising receiving at least one configuration that specifies: at least one first resource for channel measurements; and at least one second resource for interference measurements.
Aspect 11: The method of aspect 10, wherein: the conducting the Layer 1 measurement comprises measuring at least one first signal on the at least one first resource and at least one second signal on the at least one second resource; and the generating the measurement report comprises generating a Layer 1 signal-to-interference-and-noise ratio (L1-SINR) measurement metric based on the Layer 1 measurement.
Aspect 12: The method of any of aspects 10 through 11, wherein at least one of: the at least one first resource comprises at least one channel measurement resource (CMR) set; or the at least one second resource comprises at least one interference measurement resource (IMR) set.
Aspect 13: The method of aspect 12, wherein at least one of: the CMR set comprises at least one of a first periodic resource, a first semi-persistent resource, or a first aperiodic resource; or the IMR set comprises at least one of a second periodic resource, a second semi-persistent resource, or a second aperiodic resource.
Aspect 14: The method of any of aspects 1 through 13, further comprising receiving at least one configuration that specifies at least one of: a single channel measurement resource (CMR) set for a single transmit receive point (TRP) measurement operation; or multiple CMR sets for a multiple TRP measurement operation.
Aspect 15: The method of aspect 14, wherein: the conducting the Layer 1 measurement comprises measuring at least one first signal on the single CMR set or at least one second signal on the multiple CMR sets; and the generating the measurement report comprises generating a Layer 1 reference signal received power (L1-RSRP) measurement metric based on the Layer 1 measurement.
Aspect 16: The method of any of aspects 14 through 15, wherein at least one of: the single CMR set comprises at least one of a first periodic resource, a first semi-persistent resource, or a first aperiodic resource; or the multiple CMR sets comprise at least one of second periodic resources, second semi-persistent resources, or second aperiodic resources.
Aspect 17: A method for wireless communication at a user equipment, the method comprising: receiving a sounding reference signal (SRS) configuration associated with a Layer 1 mobility measurement; and transmitting an SRS transmission based on the SRS configuration to a candidate cell.
Aspect 18: The method of aspect 17, wherein the SRS transmission comprises: an inter-frequency SRS transmission; or an intra-frequency SRS transmission.
Aspect 19: The method of any of aspects 17 through 18, wherein the SRS configuration specifies that the SRS transmission is to be transmitted periodically, semi-persistently, or aperiodically.
Aspect 20: The method of aspect 17, wherein: the SRS transmission comprises a Layer 1 inter-frequency SRS transmission; and the SRS configuration specifies at least one first SRS parameter associated with a serving cell of the user equipment and at least one second SRS parameter associated with the candidate cell.
Aspect 21: The method of aspect 20, wherein the at least one first SRS parameter is different from the at least one second SRS parameter.
Aspect 22: The method of aspect 21, wherein the at least one second SRS parameter comprises at least one of a center frequency, a sub-carrier spacing (SCS), or a bandwidth part (BWP).
Aspect 23: The method of any of aspects 17 through 22, wherein the SRS configuration specifies at least one guard time between the SRS transmission and any other communication by the user equipment.
Aspect 24: The method of aspect 23, wherein the at least one guard time specifies at least one of: a first quantity of symbols before the SRS transmission, or a second quantity of symbols after the SRS transmission.
Aspect 25: The method of aspect 24, wherein: at least one of the first quantity of symbols or the second quantity of symbols is a fixed value; or at least one of the first quantity of symbols or the second quantity of symbols is based on a capability of the user equipment.
Aspect 26: The method of aspect 24, wherein at least one of the first quantity of symbols or the second quantity of symbols is based on a sub-carrier spacing (SCS) of: a serving cell of the user equipment; or the candidate cell.
Aspect 27: The method of any of aspects 23 through 26, further comprising: conducting radio frequency tuning during the at least one guard time.
Aspect 28: The method of any of aspects 17 through 27, further comprising: receiving, from a serving cell, a cell switch command via a first Layer 1 message or via a first Layer 2 message, the cell switch command identifying the candidate cell for handover of the user equipment; and transmitting a handover complete message to the candidate cell in response to the cell switch command, the handover complete message being transmitted via a second Layer 1 message or via a second Layer 2 message.
Aspect 29: A user equipment comprising: a transceiver configured to communicate with a radio access network, one or more memories storing processor-executable code; and one or more processors configured to execute the processor executable code and cause the user equipment to perform any one or more of aspects 1 through 16.
Aspect 30: An apparatus configured for wireless communication comprising at least one means for performing any one or more of aspects 1 through 16.
Aspect 31: A non-transitory computer-readable medium storing computer-executable code, comprising code for causing an apparatus to perform any one or more of aspects 1 through 16.
Aspect 32: A user equipment comprising: a transceiver configured to communicate with a radio access network, one or more memories storing processor-executable code; and one or more processors configured to execute the processor executable code and cause the first network entity to perform any one or more of aspects 17 through 28.
Aspect 33: An apparatus configured for wireless communication comprising at least one means for performing any one or more of aspects 17 through 28.
Aspect 34: A non-transitory computer-readable medium storing computer-executable code, comprising code for causing an apparatus to perform any one or more of aspects 17 through 28.
Aspect 35: A first network entity for wireless communication, including: one or more memories storing processor-executable code; and one or more processors configured to execute the processor executable code and cause the first network entity to: generate a set of measurement results associated with one or more beams, where the one or more beams are associated with one or more candidate special cells (SpCells) for Layer 1 (L1) or Layer 2 (L2) mobility; and transmit, to a second network entity, a beam report for the one or more beams, where the beam report is based on the set of measurement results.
Aspect 36: The first network entity of aspect 35, where the beam report is aperiodic, and where the one or more processors are further configured to execute the processor executable code and cause the first network entity to: receive, from the second network entity, downlink control information (DCI) triggering the beam report for the one or more beams.
Aspect 37: The first network entity of aspect 35, where the beam report is periodic or semi-persistent.
Aspect 38: The first network entity of aspect 35, where the one or more processors are further configured to execute the processor executable code and cause the first network entity to: determine to transmit the beam report based on a trigger event based on a measurement result of the set of measurement results associated with one candidate SpCell of the one or more candidate SpCells.
Aspect 39: The first network entity of aspect 38, where the measurement result is one of: a L1 reference signal received power (RSRP), a L1 reference signal received quality (RSRQ), a L1 signal-to-interference and noise ratio (SINR), or a block error rate (BLER).
Aspect 40: The first network entity of any of aspects 38-39, where the trigger event is based on the measurement result being higher than a measurement threshold.
Aspect 41: The first network entity of any of aspects 38-40, where the trigger event includes an initial event and an exit event, where the initial event is based on the measurement result being higher than a measurement threshold plus a hysteresis parameter, and where the exit event is based on the measurement result being lower than the measurement threshold minus the hysteresis parameter.
Aspect 42: The first network entity of any of aspects 38-39, where the trigger event is based on the measurement result being higher than a second measurement result associated with a serving cell plus a measurement threshold.
Aspect 43: The first network entity of any of aspects 38-39 or 42, where the trigger event includes an initial event and an exit event, where the initial event is based on Mn+Ofn+Ocn−Hys>Mp+Ofp+Ocp+Off, where the exit event is based on Mn+Ofn+Ocn+Hys<Mp+Ofp+Ocp+Off, where: Mn is indicative of the measurement result, Ofn is indicative of a measurement object offset associated with the candidate SpCell, Ocn is indicative of a cell specific offset associated with the candidate SpCell, Ofp is indicative of a measurement object offset associated with a serving cell, Ocp is indicative of a cell specific offset associated with the serving cell, Mp is indicative of the second measurement result, Off is indicative of an offset parameter associated with the trigger event, and Hys is indicative of a hysteresis parameter.
Aspect 44: The first network entity of any of aspects 35-43, where the one or more processors are further configured to execute the processor executable code and cause the first network entity to: start a prohibit timer after the at least one processor is configured to transmit the beam report; and refrain from transmitting a second beam report while the prohibit timer is running.
Aspect 45: The first network entity of any of aspects 35-44, where to transmit the beam report, the one or more processors are further configured to execute the processor executable code and cause the first network entity to: transmit, to the second network entity, a scheduling request for the beam report.
Aspect 46: The first network entity of any of aspects 35-45, where the beam report is included in uplink control information (UCI), where the UCI is included in a physical uplink control channel (PUCCH) transmission, a dynamic grant (DG) physical uplink shared channel (PUSCH) transmission, or a configured grant (CG) PUSCH transmission.
Aspect 47: The first network entity of aspect 46, where the UCI is a single part UCI including information indicative of the one or more beams and information indicative of the set of measurement results.
Aspect 48: The first network entity of aspect 46, where the UCI includes a first part and a second part, where the first part is indicative of a cell identifier and a subset of beams of the one or more beams associated with each candidate SpCell of the one or more candidate SpCells, and where the second part is indicative of at least one beam identifier associated with the subset of beams and a subset of measurement results of the set of measurement results associated with each candidate SpCell of the one or more candidate SpCells.
Aspect 49: The first network entity of any of aspects 46-48, where the UCI is associated with a priority equal to a second priority of a second UCI including a second beam report associated with an active serving cell.
Aspect 50: The first network entity of any of aspects 46-48, where the UCI is associated with a priority lower than a second priority associated with a second UCI including a second beam report associated with an active serving cell.
Aspect 51: The first network entity of any of aspects 35-45, where the beam report is included in medium access control (MAC) control element (MAC-CE) indicative of one or more candidate cell identifiers respectively associated with the one or more candidate SpCells.
Aspect 52: The first network entity of aspect 51, where the MAC-CE is indicative of a subset of beams of the one or more beams and a subset of measurement results of the set of measurement results for each candidate SpCell of the one or more candidate SpCells.
Aspect 53: A first network entity for wireless communication, including: one or more memories storing processor-executable code; and one or more processors configured to execute the processor executable code and cause the first network entity to: establish a connection with a second network entity; and receive a beam report for one or more beams associated with the second network entity, where the one or more beams are associated with one or more candidate special cells (SpCells) for Layer 1 (L1) or Layer 2 (L2) mobility, where the beam report is based on a set of measurement results associated with the one or more beams, where the one or more beams are associated with the one or more candidate SpCells for the L1 or L2 mobility.
Aspect 54: The first network entity of aspect 53, where the beam report is aperiodic, and where the one or more processors are further configured to execute the processor executable code and cause the first network entity to: transmit, for the second network entity, downlink control information (DCI) triggering the beam report for the one or more beams.
Aspect 55: The first network entity of aspect 53, where the beam report is periodic or semi-persistent.
Aspect 56: The first network entity of any of aspects 53-55, where the beam report is included in uplink control information (UCI), where the UCI is included in a physical uplink control channel (PUCCH) transmission, a dynamic grant (DG) physical uplink shared channel (PUSCH) transmission, or a configured grant (CG) PUSCH transmission.
Aspect 57: The first network entity of aspect 56, where the UCI is a single part UCI including information indicative of the one or more beams and information indicative of the set of measurement results.
Aspect 58: The first network entity of aspect 56, where the UCI includes a first part and a second part, where the first part is indicative of a cell identifier and a subset of beams of the one or more beams associated with each candidate SpCell of the one or more candidate SpCells, and where the second part is indicative of at least one beam identifier associated with the subset of beams and a subset of measurement results of the set of measurement results associated with each candidate SpCell of the one or more candidate SpCells.
Aspect 59: The first network entity of any of aspects 56-58, where the UCI is associated with a priority equal to a second priority of a second UCI including a second beam report associated with an active serving cell.
Aspect 60: The first network entity of any of aspects 56-58, where the UCI is associated with a priority lower than a second priority associated with a second UCI including a second beam report associated with an active serving cell.
Aspect 61: The first network entity of any of aspects 53-55, where the beam report is included in medium access control (MAC) control element (MAC-CE) indicative of one or more candidate cell identifiers respectively associated with the one or more candidate SpCells.
Aspect 62: The first network entity of aspect 61, where the MAC-CE is indicative of a subset of beams of the one or more beams and a subset of measurement results of the set of measurement results for each candidate SpCell of the one or more candidate SpCells.
Aspect 63: A method of wireless communication for implementing any of aspects 35 to 52.
Aspect 64: An apparatus for wireless communication including means for implementing any of aspects 35 to 52.
Aspect 65: A computer-readable medium (e.g., a non-transitory computer-readable medium) storing computer executable code, where the code when executed by a processor causes the processor to implement any of aspects 35 to 52.
Aspect 66: A method of wireless communication for implementing any of aspects 53 to 62.
Aspect 67: An apparatus for wireless communication including means for implementing any of aspects 53 to 62.
Aspect 68: A computer-readable medium (e.g., a non-transitory computer-readable medium) storing computer executable code, where the code when executed by a processor causes the processor to implement any of aspects 53 to 62.

Several aspects of a wireless communication network have been presented with reference to an example implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP 2), such as CDMA 2000 and/or Evolution-Data Optimized (EV-DO). Other examples may be implemented within systems employing Institute of Electrical and Electronics Engineers (IEEE) 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, the term “determining” may include, for example, ascertaining, resolving, selecting, choosing, establishing, calculating, computing, processing, deriving, investigating, looking up (e.g., looking up in a table, a database or another data structure), and the like. Also, “determining” may include receiving (e.g., receiving information), accessing (e.g., accessing data in a memory), and the like.

One or more of the components, steps, features and/or functions illustrated in FIGS. 1-30 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-4, 7-12, 14-16, 18, 21, 24, 29, and 30 may be configured to perform one or more of the methods, features, or steps escribed herein. The novel algorithms described herein may also be efficiently implemented in software and/or embedded in hardware.

It is to be understood that the specific order or hierarchy of steps in the methods disclosed is an illustration of example processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A first network entity, comprising:
one or more memories storing processor-executable code; and
one or more processors configured to execute the processor-executable code and cause the first network entity to:
generate a set of measurement results associated with one or more beams, wherein the one or more beams are associated with one or more candidate special cells (SpCells) for Layer 1 (L1) or Layer 2 (L2) mobility; and
transmit, to a second network entity, a beam report for the one or more beams, wherein the beam report is based on the set of measurement results.

2. The first network entity of claim 1, wherein the beam report is included in uplink control information (UCI).

3. The first network entity of claim 2, wherein the UCI is included in at least one of:
a physical uplink control channel (PUCCH) transmission;
a dynamic grant (DG) physical uplink shared channel (PUSCH) transmission; or
a configured grant (CG) PUSCH transmission.

4-13. (canceled)

14. A user equipment, comprising:
one or more memories storing processor-executable code; and
one or more processors configured to execute the processor-executable code and cause the user equipment to:
conduct a Layer 1 measurement based on a reference signal received from a first cell;
generate a measurement report based on the Layer 1 measurement; and
transmit the measurement report to a second cell via a Layer 1 message.

15. The user equipment of claim 14, wherein the Layer 1 message comprises uplink control information (UCI).

16. The user equipment of claim 14, wherein the reference signal comprises a channel state information-reference signal (CSI-RS) or a synchronization signal block (SSB) signal.

17. The user equipment of claim 14, wherein the one or more processors are further configured to execute the processor-executable code and cause the user equipment to receive a configuration that specifies at least one of:
at least one first measurement metric for an inter-frequency Layer 1 measurement; or
at least one second measurement metric for an intra-frequency Layer 1 measurement.

18. The user equipment of claim 17, wherein the configuration is based on at least one capability of the user equipment.

19. The user equipment of claim 17, wherein the at least one first measurement metric comprises at least one of a Layer 1 reference signal received power (L1-RSRP), a Layer 1 reference signal received quality (L1-RSRQ), or a Layer 1 signal-to-interference-and-noise ratio (L1-SINR).

20. The user equipment of claim 17, wherein the at least one second measurement metric comprises at least one of a Layer 1 reference signal received power (L1-RSRP), or a Layer 1 signal-to-interference-and-noise ratio (L1-SINR).

21. The user equipment of claim 14, wherein:
the measurement report comprises a measurement metric associated with a beam-level measurement; or
the measurement report comprises a measurement metric associated with a cell-level measurement.

22. The user equipment of claim 14, wherein the one or more processors are further configured to execute the processor-executable code and cause the user equipment to:
receive, from the second cell, a cell switch command via a first Layer 1 message or via a first Layer 2 message, the cell switch command identifying the first cell for handover of the user equipment; and
transmit a handover complete message to the first cell in response to the cell switch command, the handover complete message being transmitted via a second Layer 1 message or via a second Layer 2 message.

23. The user equipment of claim 14, wherein the one or more processors are further configured to execute the processor-executable code and cause the user equipment to receive at least one configuration that specifies:
at least one first resource for channel measurements; and
at least one second resource for interference measurements.

24. The user equipment of claim 23, wherein:
to conduct the Layer 1 measurement, the one or more processors are further configured to execute the processor-executable code and cause the user equipment to measure at least one first signal on the at least one first resource and at least one second signal on the at least one second resource; and
to generate the measurement report, the one or more processors are further configured to execute the processor-executable code and cause the user equipment to generate a Layer 1 signal-to-interference-and-noise ratio (L1-SINR) measurement metric based on the Layer 1 measurement.

25. The user equipment of claim 23, wherein at least one of:
the at least one first resource comprises at least one channel measurement resource (CMR) set; or
the at least one second resource comprises at least one interference measurement resource (IMR) set.

26. The user equipment of claim 25, wherein at least one of:
the CMR set comprises at least one of a first periodic resource, a first semi-persistent resource, or a first aperiodic resource; or
the IMR set comprises at least one of a second periodic resource, a second semi-persistent resource, or a second aperiodic resource.

27. The user equipment of claim 14, wherein the one or more processors are further configured to execute the processor-executable code and cause the user equipment to receive at least one configuration that specifies at least one of:
a single channel measurement resource (CMR) set for a single transmit receive point (TRP) measurement operation; or
multiple CMR sets for a multiple TRP measurement operation.

28. The user equipment of claim 27, wherein:
to conduct the Layer 1 measurement, the one or more processors are further configured to execute the processor-executable code and cause the user equipment to measure at least one first signal on the single CMR set or at least one second signal on the multiple CMR sets; and
to generate the measurement report, the one or more processors are further configured to execute the processor-executable code and cause the user equipment to generate a Layer 1 reference signal received power (L1-RSRP) measurement metric based on the Layer 1 measurement.

29. The user equipment of claim 27, wherein at least one of:
the single CMR set comprises at least one of a first periodic resource, a first semi-persistent resource, or a first aperiodic resource; or
the multiple CMR sets comprise at least one of second periodic resources, second semi-persistent resources, or second aperiodic resources.

30. A method for wireless communication at a user equipment, the method comprising:
conducting a Layer 1 measurement based on a reference signal received from a first cell;
generating a measurement report based on the Layer 1 measurement; and
transmitting the measurement report to a second cell via a Layer 1 message.
